(19) United States
(12) Patent Application Publication
(10) Pub. No.: US 2026/0030368 A1
(43) Pub. Date: Jan. 29, 2026

(54) SYSTEMS, METHODS, AND MEDIA FOR VIRTUAL DISK DEVICES

(71) Applicant: Cybervore, Inc., Red Bank, NJ (US)

(72) Inventor: David J. Falkenberg, Neptune City, NJ (US)

(21) Appl. No.: 19/283,166

(22) Filed: Jul. 28, 2025

Related U.S. Application Data
(60) Provisional application No. 63/676,311, filed on Jul. 26, 2024.

(51) Int. Cl. G06F 21/60; G06F 16/178

(52) U.S. Cl. CPC G06F 21/602; G06F 16/178

(57) ABSTRACT

Mechanisms for storing an input file include: receiving the input file at a virtual disk drive; encrypting the input file into a first instance of an encrypted file; splitting the first instance of the encrypted file into a first plurality of fragments; adding a fragment control structure to each fragment of the first plurality of fragments; and storing each fragment of the first plurality of fragments to a corresponding storage location. Some of the mechanisms further include making an entry in a directory control structure to record the corresponding storage location for each fragment of the first plurality of fragments. Some of the mechanisms further include: creating replicas, wherein each of the replicas is a replica of one of the plurality of fragments; storing replicas to replica storage locations; and recording identifiers of the replica storage locations in the directory control structure.

### CROSS-REFERENCE TO RELATED APPLICATION

This application claims the benefit of U.S. Provisional Patent Application No. 63/676,311, filed Jul. 26, 2024, which is hereby incorporated by reference herein in its entirety.

### BACKGROUND

Protecting confidential data from unauthorized access and destruction is of critical importance. Current techniques of protecting data include restricting access to storage devices (such as services) on which the data is stored, encrypting the data, and backing-up the data.

For some data, such techniques do not provide adequate security.

Accordingly, mechanisms for virtual disk drives are desirable.

### SUMMARY

In accordance with some embodiments, mechanisms, including systems, methods, and media for virtual disk devices are provided.

In some embodiments, methods for storing an input file are provided, the methods comprising: receiving the input file at a virtual disk drive; encrypting the input file into a first instance of an encrypted file; splitting the first instance of the encrypted file into a first plurality of fragments, using a hardware processor; adding a fragment control structure to each fragment of the first plurality of fragments; and storing each fragment of the first plurality of fragments to a corresponding storage location. In some of these embodiments, the method further comprises making an entry in a directory control structure to record the corresponding storage location for each fragment of the first plurality of fragments. In some of these embodiments, the method further comprises: creating replicas, wherein each of the replicas is a replica of one of the plurality of fragments; storing replicas to replica storage locations; and recording identifiers of the replica storage locations in the directory control structure. In some of these embodiments, no two replicas are located in the same storage location. In some of these embodiments, the method further comprises creating a fragment from one of the replicas. In some of these embodiments, creating the fragment is performed using instructions stored in at least one of the other fragments. In some of these embodiments, the method further comprises: for each fragment of the first plurality of fragments: adding random bits to the fragment; and hashing locations of the random bits into the fragment control structure of the fragment. In some of these embodiments, the fragments are randomly or pseudo-randomly sized. In some of these embodiments, the method further comprises: determining storage locations of the fragments; retrieving the fragments from the storage locations; determining the locations of the random bits in the fragments; removing the random bits from the fragments; removing the fragment control structure from each of the fragments; joining the fragments into a second instance of the encrypted file; decrypting the second instance of the encrypted file to form a decrypted file. In some of these embodiments, the decrypted file is stored in a cache. In some of these embodiments, the method further comprises: encrypting the decrypted file to form a re-encrypted file and storing the re-encrypted file in a cache. In some of these embodiments, each fragment is stored as a fragment file in a storage location and the method further comprises: extracting metadata from the input file; setting an owner of each fragment file to a user account associated with a mechanism for storing the fragment; and setting an owner of an output file to be a user specified in the metadata, wherein the output file is based on the decrypted file. In some of these embodiments, the method further comprises setting a security setting of the output file to be a security setting specified in the metadata. In some of these embodiments, storing each fragment of the first plurality of fragments to a corresponding storage location is performed non-sequentially. In some of these embodiments, storing each fragment of the first plurality of fragments to a corresponding storage location is performed in a random or pseudo-random order. In some of these embodiments, the method further comprises: after storing each fragment of the plurality of fragments, in response to a command to save or modify the input file: encrypting the input file into a third instance of an encrypted file; splitting the third instance of the encrypted file into a second plurality of fragments; adding a fragment control structure to each fragment of the second plurality of fragments; storing each fragment of the second plurality of fragments to a corresponding storage location; and creating and storing a version identifier associated with the second plurality of fragments. In some of these embodiments, the method further comprises: tracking a number of versions of the input file; and deleting an oldest plurality of fragments corresponding to the input file when the number of versions reaches a threshold. In some of these embodiments, the method further comprises: for each storage location, access each fragment stored therein; decrypt the fragment control structure; compare data in the fragment control structure to data in a directory control structure; and adding the data to the directory control structure if matching data is not present in the directory control structure. In some of these embodiments, the method further comprises: for each storage location, access each fragment stored therein; decrypt the fragment control structure; and adding data from the fragment control structure to the directory control structure. In some of these embodiments, the method further comprises storing a fragment of a first input file and a fragment of a second input file in a single cluster within a storage location. In some of these embodiments, the method further comprises blocking access to the plurality of fragments in response to a user command. In some of these embodiments, the method further comprises blocking access to the plurality of fragments in response to a proximity determination. In some of these embodiments, the method further comprises blocking access to the plurality of fragments in response to detecting anomalous activity. In some of these embodiments, the method further comprises blocking access to the plurality of fragments in response to a notification. In some of these embodiments, the method further comprises creating a fragment from contents of other fragments. In some of these embodiments, creating the fragment is performed using instructions stored in at least one of the other fragments. In some of these embodiments, the encrypting the input file into a first instance of an encrypted file in performed in response to authenticating a first user, and the method further comprises: in response to authenticating a second user: determining storage locations of the fragments; retrieving the fragments from the storage locations; determining the locations of the random bits in the fragments; removing the random bits from the fragments; removing the fragment control structure from each of the fragments; joining the fragments into a second instance of the encrypted file; and decrypting the second instance of the encrypted file to form a decrypted file. In some of these embodiments, the method further comprises: receiving a request to access a file; determining if a threshold number of users have been authenticated; and in response to determining that the threshold number of users have been authenticated, granting access to the file.

In some of embodiments, systems for storing an input file are provide, the systems comprising: memory; and at least one hardware processor coupled to the memory and collectively configured to at least: receive the input file at a virtual disk drive; encrypt the input file into a first instance of an encrypted file; split the first instance of the encrypted file into a first plurality of fragments; add a fragment control structure to each fragment of the first plurality of fragments; and store each fragment of the first plurality of fragments to a corresponding storage location.

In some embodiments, non-transitory computer-readable media containing computer executable instructions that, when executed by a processor, cause the processor to perform a method for storing an input file are provided, the method comprising: receiving the input file at a virtual disk drive; encrypting the input file into a first instance of an encrypted file; splitting the first instance of the encrypted file into a first plurality of fragments; adding a fragment control structure to each fragment of the first plurality of fragments; and storing each fragment of the first plurality of fragments to a corresponding storage location.

### BRIEF DESCRIPTION OF THE DRAWINGS

FIG. 1 illustrates an example of architecture in accordance with some embodiments.

FIG. 2 illustrates an example of a technique for implementing fragmented object storage in accordance with some embodiments.

FIG. 3 illustrates examples of chain control blocks that can be used in accordance with some embodiments.

FIG. 4 illustrates an example of a fragment header in accordance with some embodiments.

FIG. 5 illustrates an example of a chain schema in accordance with some embodiments.

FIG. 6 illustrates an example of a storage hierarchy in accordance with some embodiments.

FIG. 7 illustrates an example of file storing and retrieval processes in accordance with some embodiments.

FIGS. 8 and 9 illustrate examples of file paging operations in accordance with some embodiments.

FIG. 10 illustrates an example of swapping and paging windows in accordance with some embodiments.

FIG. 11 illustrates an example of a Merkle Tree in accordance with some embodiments.

### DETAILED DESCRIPTION

### Overview

In accordance with some embodiments, virtual disk devices (VDDs) are provided. In some embodiments, these VDDs provide security for data contained on storage devices (which can be local devices or cloud based, in some embodiments) by utilization of fragmentation and encryption of stored data. In some embodiments, these VDDs protect information by encrypting the data and then dividing the data into fragments which are then distributed across different storage resources.

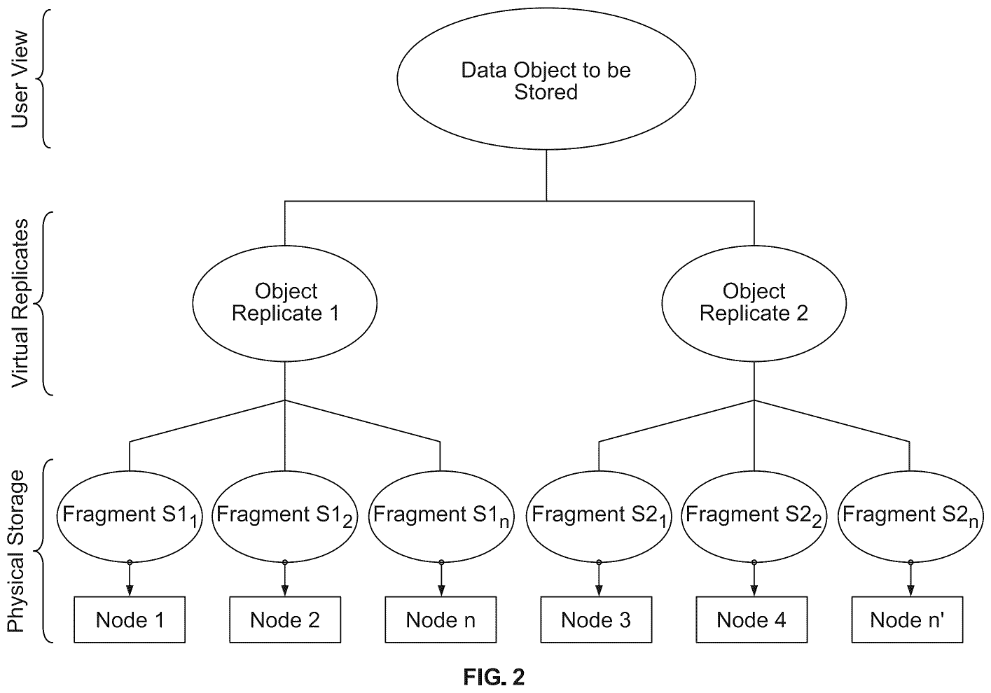

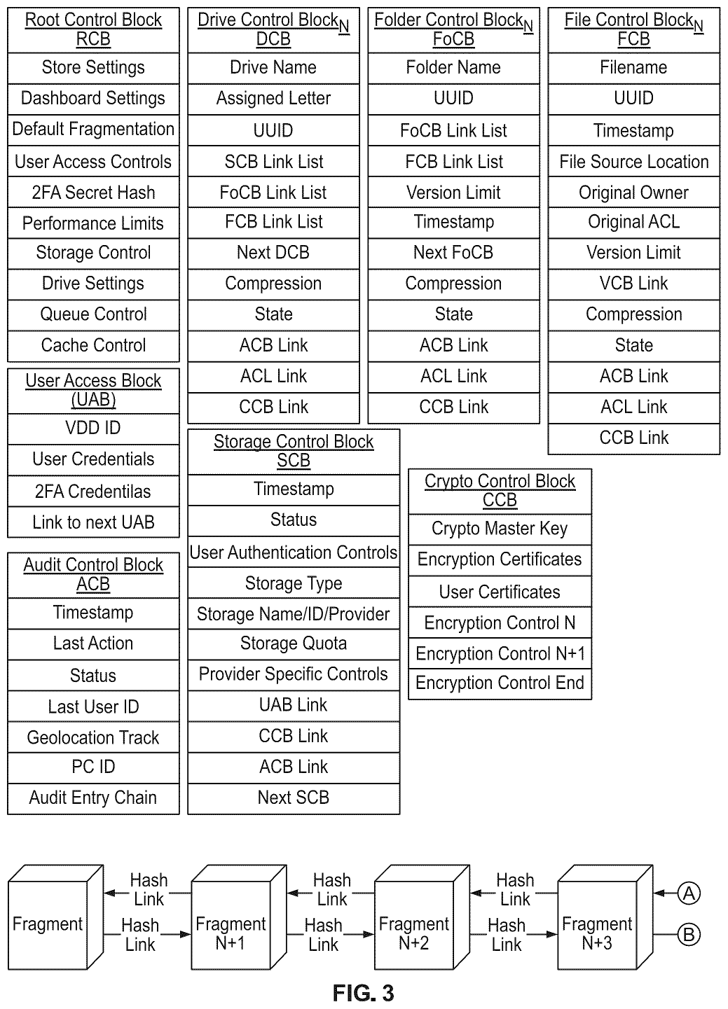

In some embodiments, the VDDs expand the reliability, accessibility, and security of data stored digitally by creating a secure file system on computing devices, storage devices, and virtual storage resources (e.g., clouds), in some embodiments. This can be accomplished by the introduction of controlled chaos into the methods of storage, in some embodiments. As shown in FIG. 2, the chaos can be introduced when the data is replicated and then fractured into pieces that are then scattered to different storage locations as well as optionally encrypted and compressed, in some embodiments. However, since the chaos is controlled, the scattered fragments can be gathered on demand and accessed as usual, in some embodiments. Although somewhat counterintuitive, fragmenting and scattering the data makes it more accessible, reliable and very secure, in some embodiments. The chaos introduction creates diffusion, confusion, and convolution, plus when coupled with encryption of the fragments makes retrieval by unauthorized persons very difficult, in some embodiments.

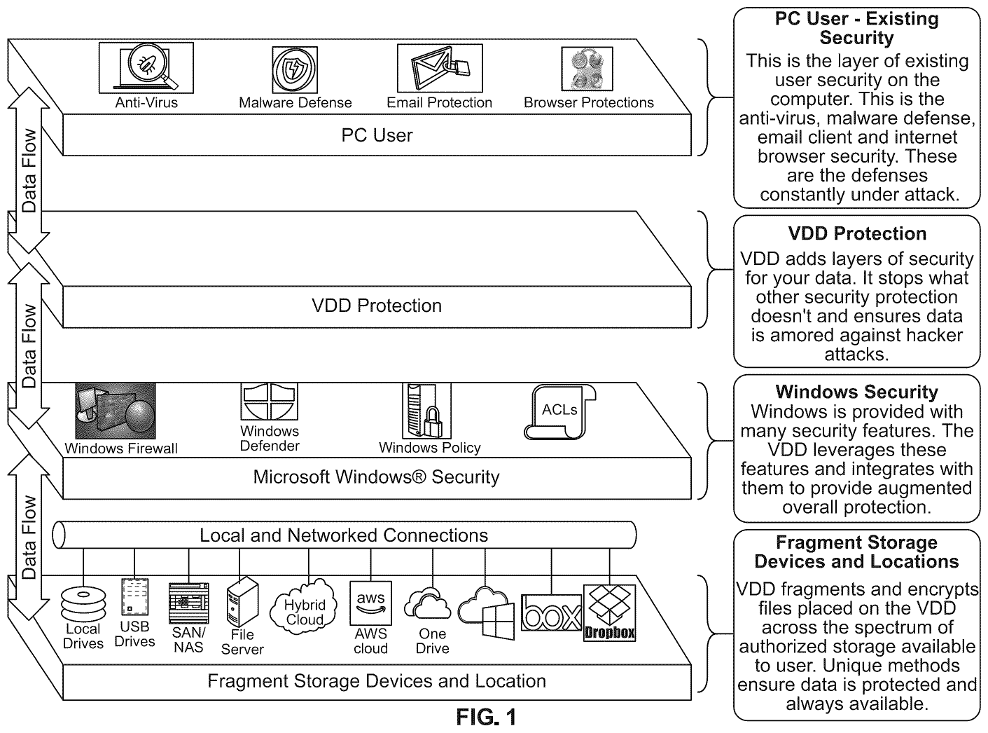

In accordance with some embodiments, as shown in FIG. 1, the VDDs provide drive construct interfaces to fragmented data files (hereinafter, referred to as fragment drives) that allow users to access protected, fragmented data in a similar way as any other file on a drive for the given operating system. The VDDs can utilize local storage devices (e.g., local disk, USB drives, etc.), network access devices (e.g., NAS, SAN, etc.), cloud storage, and/or any other suitable storage devices to store distributed data fragments, in some embodiments. In some embodiments, the VDDs allow users to specify one or more encryption techniques to be used, a number of fragments into which each file is to be split, and/or replication options.

In some embodiments, fragmentation works to improve information protection because it makes the task of ‘brute forcing’ or cracking the protected information more complex. In some embodiments, fragmentation adds complexity by making it difficult to know where the information starts, where the middle of the information is, and what is the end of the information. The more fragments the information is split into, the more difficult it becomes to access that information, in some embodiments.

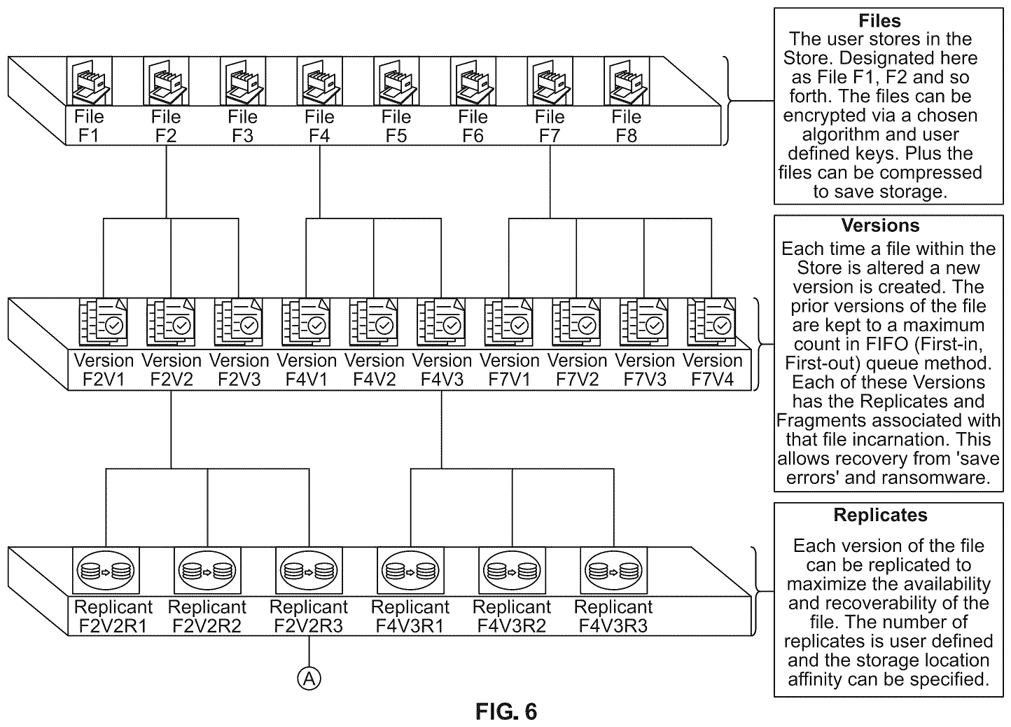

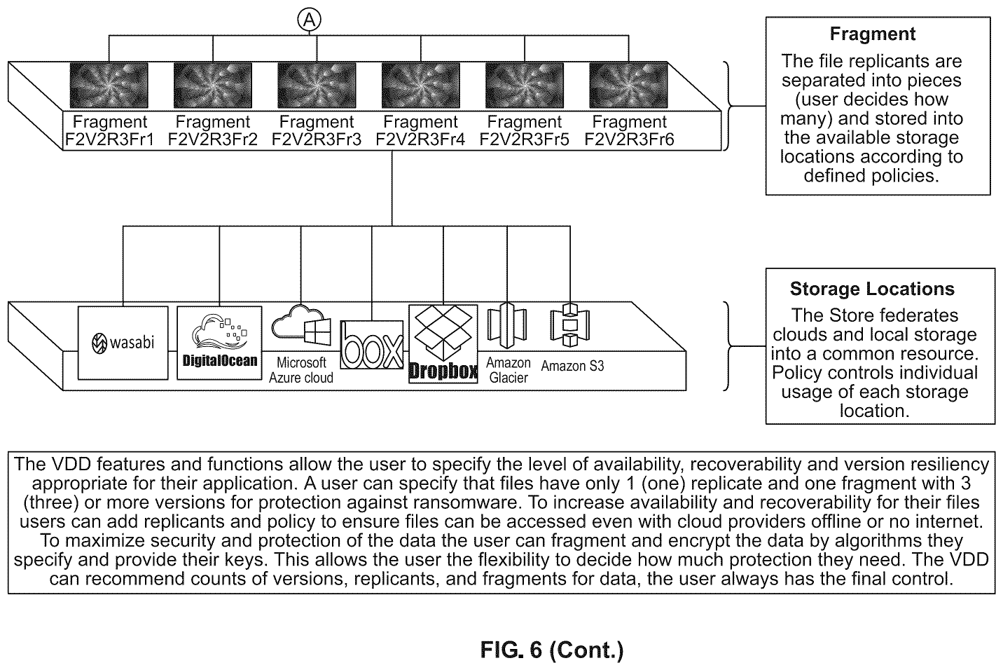

In some embodiments, as shown in FIG. 6, fragment file versioning is provided which protects against unauthorized changes, such as from ransomware, and allows a user to recover prior document content easily. In some embodiments, fragment file versioning can create a copy (version) of a given file whenever the file is altered or deleted. In some embodiments, fragment file versioning can include a way to limit the versions created on the fragment drive using a first-in, first-out approach. In some embodiments, prior versions may only be accessible using a fragment application to access a VDD.

In some embodiments, in order to manage and maintain a VDD, a hierarchical directory structure can be used. To achieve this, in some embodiments, a database can be hidden among data fragments along with a directory structure that is backed up within the data fragments. In some embodiments, this database can maintain date/time stamps, access control lists (ACLs), access control entries (ACEs), and/or any other suitable information and/or metadata generally associated with file systems.

In some embodiments, the VDDs can include the ability to scan, verify, and repair themselves. In some embodiments, in order to do so, the VDDs can use data from a fragment drive directory structure and data hidden within data fragments to recover from interrupted or failed operations that may have corrupted a fragment drive structure. In some embodiments, a VDD can run one or more verification passes on itself on a regular or irregular basis to validate the VDD's structure. In some embodiments, a user may also run a process to recover from suspected corruption on demand.

In some embodiments, a VDD can employ security mechanisms to protect its fragmented data from unauthorized access. The security mechanisms can designate a given user as being highly privileged, in some embodiments. The fragment-drive-controlled files and data fragments can be ‘owned’ by this user, in some embodiments. In some embodiments, this may block direct access to the low-level fragments except via the VDD. In some embodiments, the file fragments and the data files on a VDD can have extended ACL/ACE definitions that allow the control of access by user, time of day, access location, and more.

In some embodiments, in order to have efficient space utilization on data storage locations, a mode of operation for data fragments termed ‘stuffed’ can be implemented. In some embodiments, the physical data storage devices allocate space in set units. For example, a file that has 1,000 bytes of content may physically consume 4,000 or even possibly 16,000 bytes or more depending upon the configuration of the storage device. When ‘stuffed’ is turned on for that particular storage device, file fragments can have other fragment data added to fill out the rest of the unit allocated space, in some embodiments. In some embodiments, this may result in better utilization of allocated space, reduce storage charges significantly on many storage cloud services, and reduce overall storage utilization on storage arrays.

In some embodiments, in order to provide the maximum protection of data stored in a VDD, obfuscation data can be injected into fragments on a basis controlled by the mechanisms described herein. This obfuscation data can include entire fragments and bits of data added to fragments, in some embodiments. In order to successfully decrypt (if encrypted) and reassemble a fragment into a file, the obfuscation data may be removed first, in some embodiments. In some embodiments, the control structures and fragment headers may contain encrypted references to the obfuscation data that allows the fragment drive application to access the fragmented files.

In some embodiments, the mechanisms described herein can detect a missing fragment and then recover the missing fragment from a replicant fragment (a copy of the fragment) or recreate the missing fragment by utilizing data from other fragments of the file. The term replicate may be used interchangeably with the term replicant herein.

In some embodiments, the fragments can contain data and process code that will allow an authorized user to access the protected data without an application within the computing cloud. This allows for the ease of distribution of data within a cloud environment while providing the highest level of protection for the data, in some embodiments.

In some embodiments, a VDD can automatically recover corrupted files from malware with versioning. Once malware has been contained and removed, files corrupted by the malware can be recovered with little or no data loss automatically, in some embodiments. In some embodiments, this ability has the advantage over backup methods of little or no latency and reloading only the corrupted files, rather than a blanket recovery method being applied that is time consuming. In some embodiments, this mechanism can validate each file on the fragment drive and, if necessary, replace corrupted files with the prior version of the file.

In some embodiments, a VDD may be shut off, thereby blocking access to data stored therein. Re-enabling the VDD may have two levels of setting, in some embodiments. In the first, the user simply issues a command to turn the VDD back on, in some embodiments. In the second, the user is required to reauthenticate (zero trust) the user identity to turn the VDD back on, in some embodiments.

In some embodiments, the user can issue (via an application interface) a command to turn a VDD off, and this will block access to the data files on the VDD. In some embodiments, the user can then issue a command to turn the VDD back on, which may require reauthentication depending upon a drive setting.

In some embodiments, a VDD can be shut off when a Bluetooth device's beacon signal (within timeout) leaves the computing device's range. In some embodiments, the user has the option of specifying that the VDD automatically turn on when the device beacon is detected again.

In some embodiments, when a malware attack is detected (e.g., by policy definition) and/or when the mechanisms described herein detect unusual data access activity outside usual user patterns, a VDD can be turned off. In some embodiments, unusual data access activity can include excessive file I/O requests, unfamiliar remote IP access, and/or any other suitable unusual activity.

In some embodiments, the mechanisms described herein can receive notifications of probable malware attacks from a malware detection application or service (multiple sources are allowed, in some embodiments). For example, in some embodiments, a malware detection application may send a message alert that can be parsed to determine if a VDD should be turned off in accordance with a policy.

In some embodiments, in order to allow enterprise access to a VDD, multi-user access can be enabled. In some embodiments, each user may be required to be authorized according to a central authentication manager (e.g., a Managed Security Service Provider (MSSP), Active Directory, and/or any other suitable authentication manager). In some embodiments, any authenticated user to a named VDD may access the VDD to decrypt and reassemble fragments. In some embodiments, the mechanisms described herein control encryption keys according to a secure paradigm allowing users to access fragment drive data from multiple locations or to be transported as fragments on storage device between locations.

In some embodiments, once a user has been authorized to a given VDD, the user can be required to perform an authentication process for account setup. Once this is complete, the user can be allowed to access data on the VDD, in some embodiments. In some embodiments, the type and level of access can be controlled by the role of the account in the identity management system used.

In some embodiments, the mechanisms described herein can allow multiple simultaneous users access to data on a VDD. This can allow users to collaborate on data content, in some embodiments. Control of updates can be managed via use of queuing structures to ensure no user will overwrite another user's data changes, in some embodiments.

In some embodiments, when a cloud or internet-based identity management system is used for authentication control, VDDs can be enabled to be accessed across domain barriers. This allows the sharing of specific data sets between corporations or other entities via secure methodologies, in some embodiments.

In some embodiments, VDDs allow the connection of multiple cloud storage locations and local devices to store fragmented data. In some embodiments, the VDDs create a single interface to these multiple storage locations that allows a user of the VDDs to store fragmented data across storage clouds transparently. In addition, in some embodiments, the VDDs can arrange fragments according to one or more policies that define an affinity for cloud storage points for a given file type, age of the file, geographic location, and/or any other suitable criteria or criterion.

In some embodiments, the VDDs can allow for affinity for file types to data storage locations, data lifecycle management to move fragments per policy for age of files to different tier storage locations to manage costs of storage, and/or policies that define geographic requirements for location of files.

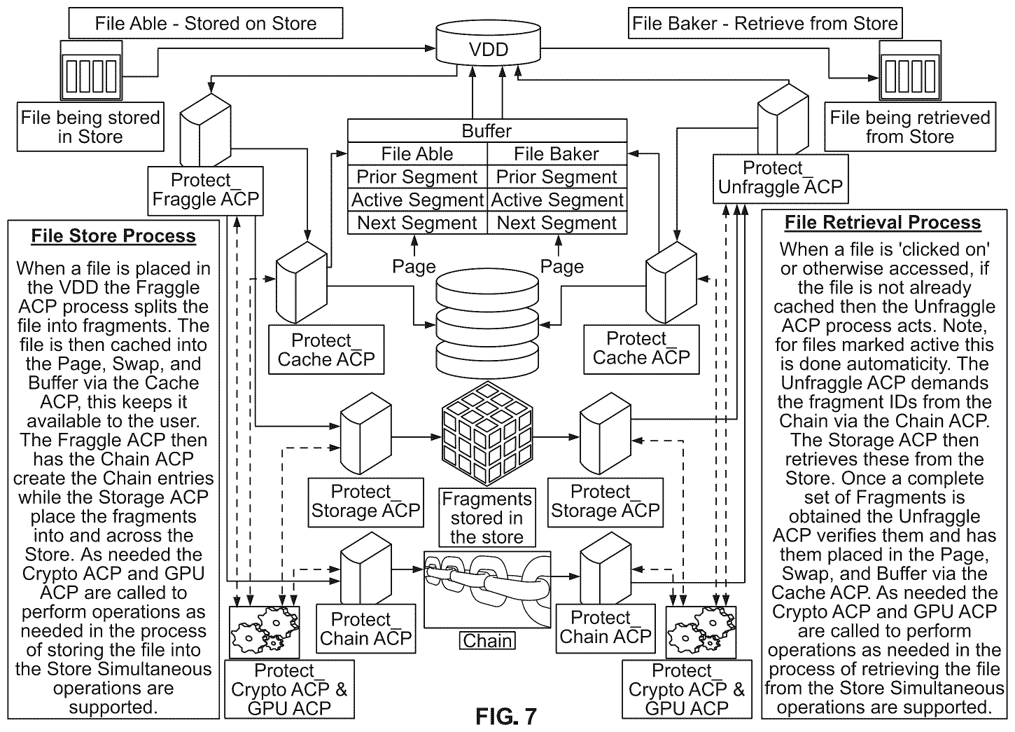

Turning to FIG. 7, in accordance with some embodiments, when a file is placed in the VDD, the file is split into fragments. The file is then cached into the page, swap, and buffer so that the file remains available to the user, in some embodiments. Chain entries are then created while the fragments are placed into and across the store, in some embodiments. Encryption may be performed on the file's data, in some embodiments.

As also shown in FIG. 7, when a file is clicked on or otherwise accessed, if the file is not already cached, then fragment IDs for the file can be obtained from the chain, in some embodiments. The fragments can then be retrieved from the store using the IDs, in some embodiments. Once a complete set of fragments is obtained, the fragments placed in the page, swap, and buffer, in some embodiments. Decryption may be performed on the file's data, in some embodiments.

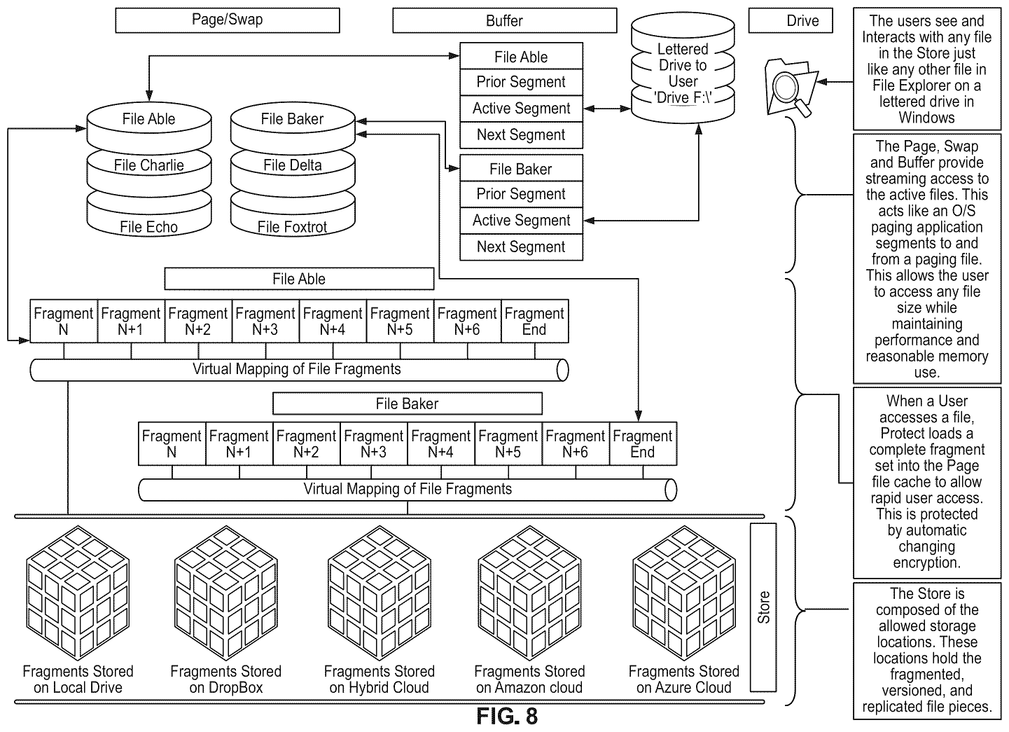

As shown in FIG. 8, in accordance with some embodiments, users see and interact with any file in the store just like any other file in File Explorer on a lettered drive in Windows. The page, swap, and buffer provide streaming access to the active files, in some embodiments. This acts like an operating system paging application that segments to and from a paging file, in some embodiments. This allows the user to access any file size while maintaining performance and reasonable memory use, in some embodiments. When a user accesses a file, a complete fragment set is loaded into the page file cache to allow rapid user access, in some embodiments. This is protected by automatic changing encryption, in some embodiments. The store is composed of the allowed storage locations, in some embodiments. These locations hold the fragmented, versioned, and replicated file pieces, in some embodiments.

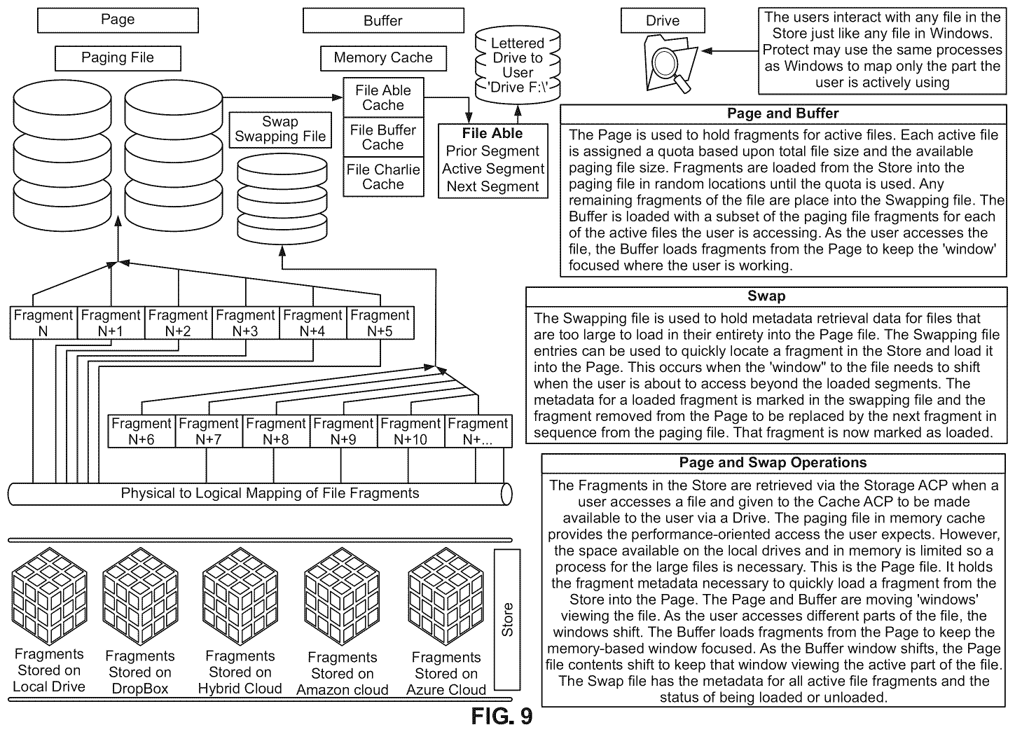

As shown in FIG. 9, the page cache can be used to hold fragments for active files, in some embodiments. Each active file can be assigned a quota based upon total file size and the available paging file size, in some embodiments. Fragments can be loaded from the store into the paging file in random locations until the quota is used, in some embodiments. Any remaining fragments of the file can be placed into the swapping file, in some embodiments. The buffer can be loaded with a subset of the paging file fragments for each of the active files the user is accessing, in some embodiments. As the user accesses the file, the buffer loads fragments from the page to keep the ‘window’ focused where the user is working, in some embodiments.

The Swapping file can be used to hold metadata retrieval data for files that are too large to load in their entirety into the page file, in some embodiments. The swapping file entries can be used to quickly locate a fragment in the store and load it into the page, in some embodiments. This can occurs when the ‘window’ to the file needs to shift when the user is about to access beyond the loaded segments, in some embodiments. The metadata for a loaded fragment can be marked in the swapping file and the fragment can be removed from the page to be replaced by the next fragment in sequence from the paging file, in some embodiments. That fragment can then be marked as loaded, in some embodiments.

The fragments in the store can be retrieved when a user accesses a file, in some embodiments. The paging file in memory cache provides performance-oriented access the user expects, in some embodiments. However, the space available on the local drives and in memory is limited, so a process for the large files is necessary, in some embodiments. This is the page file, in some embodiments. It holds the fragment metadata necessary to quickly load a fragment from the store into the page, in some embodiments. The page and buffer are moving ‘windows’ viewing the file, in some embodiments. As the user accesses different parts of the file, the windows shift, in some embodiments. The buffer loads fragments from the page to keep the memory-based window focused, in some embodiments. As the buffer window shifts, the page file contents shift to keep that window viewing the active part of the file, in some embodiments. The Swap file has the metadata for all active file fragments and the status of being loaded or unloaded, in some embodiments.

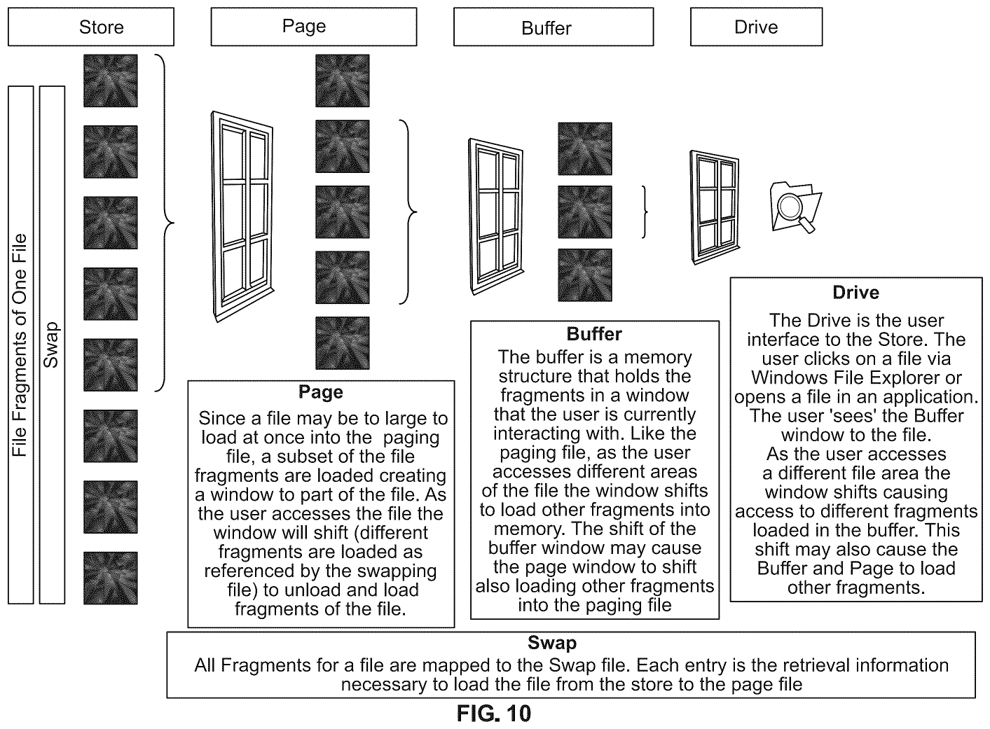

As shown in FIG. 10, since a file may be too large to load at once into the paging file, a subset of the file fragments can loaded creating a window to part of the file, in some embodiments. As the user accesses the file, the window can shift (different fragments can be loaded as referenced by the swapping file) to unload and load fragments of the file, in some embodiments.

As also shown in FIG. 10, the buffer is a memory structure that can holds fragments in a window that the user is currently interacting with, in some embodiments. Like the paging file, as the user accesses different areas of the file, the window shifts to load other fragments into memory, in some embodiments. The shift of the buffer window may cause the page window to shift also loading other fragments into the paging file, in some embodiments.

As further shown in FIG. 10, the Drive can be the user interface to the store, in some embodiments. The user can click on a file via Windows File Explorer or open a file in an application, in some embodiments. The user ‘sees’ the buffer window to the file, in some embodiments. As the user accesses a different file area, the window shifts causing access to different fragments loaded in the buffer, in some embodiments. This shift may also cause the buffer and page to load other fragments, in some embodiments.

As still further shown in FIG. 10, all Fragments for a file can be mapped to the swap file, in some embodiments. Each entry can be the retrieval information necessary to load the file from the store to the page file, in some embodiments.

### Example Implementation

In accordance with some embodiments, the mechanisms described above can be implemented in accordance with the following description of an example virtual drive application (VDA) that can be used to implement a VDD.

In some embodiments, the VDA can include several user level applications, several privileged background services and multiple utilities as described below:

### User Level Applications:

VDA_UI: This application presents the settings and monitoring dialogs to the user, in some embodiments. It also displays a tray icon that varies appearance depending upon VDA activity and state, in some embodiments. This application also displays popup balloons for major event occurrences, in some embodiments.

VDA_Report: This is a reporting application that exports information about the state of VDA, monitoring reports, event listings, etc. that can be printed or imported into other applications, in some embodiments.

VDA_Shell: This is an interface to the native shell of the operating system to VDA components, in some embodiments.

### Services:

VDA_WatchACP: This is the Watch Dog of VDA, in some embodiments. This background process watches the components of VDA for integrity of processes and databases, verifies normal operation, and controls performance plus also gathers monitoring data, in some embodiments.

VDA_StorageACP: The StorageACP interfaces with the external storage accessible by VDA, in some embodiments. This service connects the local, remote and cloud storage to VDA and manages the allocation of space, stores and retrieves fragments, and manages all I/O to the connected storage resources, in some embodiments.

VDA_CacheACP: This service controls the cache (disk and memory) that the user accesses as a lettered drive on the PC, in some embodiments. The VDDs the user interfaces with are created and managed by this service, in some embodiments. The VDA_CacheACP manages the data to keep it readily accessible by the user, in some embodiments. The service manages the VDA Page and VDA Buffer caches to allow the user to access data files without incurring a performance bottleneck, in some embodiments.

VDA_ChainACP: This service maintains and manages the VDA-Data Control which acts as the file directory to the VDA Store and also records access events, in some embodiments.

VDA_GPUACP: The GPUACP is used to process CPU intensive functions that are needed to secure and protect the data contained in the VDA Store, in some embodiments. This includes such processes such as hash calculations, crypto operations and compression algorithms, in some embodiments.

VDA_CryptoACP: The CryptoACP handles any encryption and decryption process within the VDA application, in some embodiments. It also performs the compression and decompression operations on data when selected by the user, in some embodiments. This service calls the GPUACP as necessary, in some embodiments.

VDA_VDAACP: This service is the coordinating agent when files are being stored in the VDA Store, in some embodiments. It sends and receives data as necessary to and from the other services to store the file into the VDA Store, in some embodiments.

VDA_UnVDAACP: The UnVDAACP is used to retrieve files from the VDA Store when a user ‘clicks’ a file or has an application access the file, in some embodiments. Like the VDAACP communicates with the other services to accomplish the task of retrieving the file fragments and making them available as a file to the user, in some embodiments.

VDA_MailBoxACP: This ACP is the communication controller for the services and utilities of VDA, in some embodiments. The ACP acts as an email server taking a message and transmitting to another ACP or multiple ACPs, in some embodiments. The MailBox ACP uses a shared part of the VDABuffer and the VDA Page file to transmit messages using encryption to secure the contents, in some embodiments. By using these structures message can survive a PC crash and VDA restart from where it left off, in some embodiments.

### Utilities

VDA_Scan: This utility performs a quick validation scan of the hashed links in the VDA-Data Control to detect corruption or other issues, in some embodiments.

VDA_Verify: This utility performs a deep verification of a file or files in the VDA Store, in some embodiments. This verifies both the integrity of the links in the VDA-Data Control as well as the data linked to the VDA-Data Control as fragments, in some embodiments. This may be an ‘expensive’ process in resource terms, in some embodiments.

VDA_Recovery: This utility recovers the VDA-Data Control from the stored fragments, in some embodiments. This could take extensive time to execute, in some embodiments.

VDA_Reassemble: This utility reassembles a file from the VDA Store without the VDA-Data Control, in some embodiments. This is an emergency use utility and could require considerable time to run, in some embodiments.

In some embodiments, the following services that are part of the VDA application can be installed by the installer with administrator level access and run under the VDAManager ID: VDA_WatchACP; VDA_StorageACP; VDA_CacheACP; VDA_ChainACP; VDA_GPUACP; VDA_CryptoACP; VDA_VDAACP; VDA_UnVDAACP; and VDA_MailBoxACP.

As services, they may not have graphical interface to the user, in some embodiments. Instead, an interface can be provided by the VDA_UserInterface application that communicates to the VDA services, in some embodiments.

The VDA_UI application provides the graphical interfaces for VDA to the user, in some embodiments. It runs with user level permissions and communicates with the VDA services to display status and control operation, in some embodiments. During the install process this application can be installed near the end of the process and then started with a switch that causes it to go through an initialization process for VDA, in some embodiments. When started normally, it displays a Dashboard giving general status of the application, in some embodiments.

The VDA_StorageACP service monitors the storage attached to the PC, in some embodiments. This storage can include Local, USB, ThunderBolt, SAN, NAS and Cloud locations, in some embodiments.

A task of the StorageACP during initial startup is to locate possible storage points and then the storage capacity of those locations, in some embodiments. This can be provided to the user as part of the VDADrive configuration process, in some embodiments.

In some embodiments, the user may be presented with the storage points located automatically and then be given a chance to manually add storage locations to the pool of storage resources. Once the pool is completed, the user may be asked how any VDADrives to setup (one (1) is required) and then the letter designations for each drive to be configured, in some embodiments. Once the number to be created, names, and letter designations for the VDADrives are input, the user can assign what storage locations will be used with which VDADrives, in some embodiments.

In some embodiments, the user may be requested to set the fragmentation settings for each defined VDADrive. In some embodiments, the default settings can include: Replicates: 3; Fragments: 18; Versions: 3; Maximum Lost Storage Locations: 2; Compression: Yes.

The installation process may setup one VDADrive by default, in some embodiments.

In some embodiments, the user may need to specify the encryption settings for each defined VDADrive. In some embodiments, any one of more of the following can be used:
No Encryption: NOT Recommended—A warning may be shown to the user;
AES-256: Symmetric Encryption—A single password is used to encrypt or decrypt;
General Crypto Algorithms;
Microsoft Windows Libraries: Using installed X.509 certificates for Asymmetric Encryption;
OpenPGP/GNUpgp: User can create own certificates using installed libraries; Asymmetric Encryption;
RSA or other Commercial Encryption Packages that may be installed at the location: IT personnel may need to supply details for use of these products;
Any NIST recommended algorithm for Post Quantum Data Storage; and/or
Any other suitable encryption technique.

In some embodiments, the CacheACP in conjunction with the StorageACP can create one or more VDDs on the PC (or other computing device) with user selected drive letter(s) and name(s). When implemented on Windows, the created drives can then appear in the Windows File Explorer Application and be available as an input or output destination for any Windows Application, in some embodiments.

The VDA-Data Control may need to be initialized when the ChainACP service is started working in conjunction with the StorageACP, in some embodiments. The VDA-Data Control Database can be initialized on the local PC and then setup to replicate its tables to all the allowed points of the VDA Store, in some embodiments. The VDA-Data Control can hold the ledger of all file operations and the settings of the VDA Store, in some embodiments.

In order to track the performance of VDA, a second database to hold collected monitoring data may be used, in some embodiments. This database may be separate due to the level of security required for the data contained in the VDA-Data Control records, in some embodiments. Unlike the VDA-Data Control, this database may have no sensitive information or data about the information trusted by the user to VDA, in some embodiments. The data may include Process CPU, I/O and memory resource utilization; local I/O rates for connected disk drives; and Network statistics such as transmission and received packet rate, collisions, connection/session counts, etc, in some embodiments. This data can be used by the WatchACP process to adjust VDA operations to ensure the performance of the other application on the PC are not impacted, in some embodiments. It can also be displayed in various forms to the user via dashboards and reporting mechanisms of the user interface, in some embodiments.

The Windows Performance Monitor (perfmon or WPM) can be used to monitor the performance of VDA, in some embodiments. This is proposed for two reasons. First: this is a built-in tool of windows and is designed to do the requirements for monitoring we need with the least impact on the system. Second: little developer effort will be needed to interface with the WPM to gather the data. In addition, there may be many displays modules to present the gathered data to the user via dashboards in the user interface, in some embodiments.

The WPM allows templates for monitoring to be configured and then installed to perform monitoring, in some embodiments. In some embodiments, the installer may need to do the following for WPM: Install the template into the WPM console (APIs)—The template should monitor the values described in connection with VDA-OverSeer; The template should set the database location to the VDA Data directory; and Start the monitor for VDA processes

In some embodiments, in order to ensure the best user experience possible and not consume all available throughput of a PC, the WatchACP may have the ability the throttle the CPU, I/O and Memory priorities of the VDA processes on the PC. The user can (but is not recommended to) alter the throttle controls for the services and processes of VDA, in some embodiments.

One sub-set of parameter controls is named mass file change limits (MFCL), in some embodiments. This set of controls has two purposes, in some embodiments. The first is to limit and throttle operations according to observed file change activity thus giving an administrator/user another method to regulate performance, in some embodiments. The second is to protect against ransomware or crypto-locker type malware attacks, in some embodiments. These malware attacks work by making changes to large number of files (during the encryption process) as quickly as possible, in some embodiments. The monitoring of the number of file changes per time periods allows VDA to alert an administrator and/or user to possible harmful activity and take action, in some embodiments. The parameters may allow the administrator and/or user to specify the VDA Store to ‘lock down’ (stop operations) when limits are exceeded thus stopping any further damage and allowing the user to action to resolve the cause of the excessive file change activity, in some embodiments. When resolved, normal operation can be restarted via the user interface provided via the tray icon, in some embodiments. The user data files can be recovered completely if versioning is activated on the VDA Store allowing the user to recover the file version prior to being encrypted by the malware, in some embodiments. The default setting values may be selected to protect the user's data in the VDA Store, in some embodiments.

In addition to initialization of the VDA-Data Control, the installer may need to create the base paging file that will be used to hold files in active use by the user that are not memory resident, in some embodiments. This is the same concept as used in operating systems and in read ahead disk caching to ensure performance and limit PC memory usage, in some embodiments. The initial sizing parameters may be held in the VDA-Data Control settings, in some embodiments.

Along with the VDA Page file, the paging file may also need to be initialized, in some embodiments. As with the VDA Page file, the settings for the VDA Swap are found in the settings of the VDA-Data Control, in some embodiments.

A user may be required to select a username (email address) and password at a minimum, in some embodiments. The email may need to be tested by a verification process which has the user click on a link in a transmitted email sent to the specified account, in some embodiments. The password may need to be a minimum of 9 characters which are made up of upper and lower case alphabetic characters, with at least three (3) numbers and one special character, in some embodiments. This may be required so the user may access the VDA Store from any location which has access to the storage locations, in some embodiments. The setup of emergency alternate user verification methods may also be done at this time, in some embodiments. These authorizations may be used to recover the user ID access should the regular access method be forgotten, in some embodiments. In some embodiments, only the user password can be recovered and any crypto authentication cannot be recovered.

The VDA Store may permit multiple user access via multiple credentials, in some embodiments. This may be used to support configurations where multiple users will access a common storage area, in some embodiments.

As an option, two-factor authentication may be offered to the user, in some embodiments. This implementation can use the open source Open Authentication (OATH) and related projects, in some embodiments. Google has released open source version of its authenticator application. This be used to allow a user to use their smartphone as the second factor verifier, in some embodiments. There are several versions of this code that can be used to access and leverage in the VDA application, in some embodiments. This is highly recommended to prevent hacker password stealing and gaining access to a user's VDA Store account, in some embodiments.

The user may be lead through the process of setting up two-factor authentication, in some embodiments. The setup may be modeled after the setup of the Google Two-Factor authentication process, in some embodiments. The applications for a user's phone can be Google Authenticator (recommended due to simplicity) or Authy, an open source authentication app that is compatible with the OATH libraries, etc., in some embodiments. Other 2FA method employ tokens such as Google's Titan Keys (FIDO-Fast IDentity Online), YubiKeys or Facial Recognition methods can be used in some embodiments.

In some embodiments, the VDA implementation may use Ethereum concepts. Ethereum is a popular and well tested blockchain implementation that can serve as good foundation to base the VDA-Data Control processes upon. This can be used to give developers a reference set of code to review when considering scenarios for implementation, in some embodiments. The VDA-Data Control for VDA may not require the approval process of multiple nodes used in regular blockchain implementations, in some embodiments. Instead, one node with the proper authorizations may be able to append blocks to the chain that are immutable, in some embodiments. However, since the VDA-Data Control will control data files, the attached or linked structures of the chain may need to change without causing a major processing overhead to recalculate the hashes of the entire chain, in some embodiments. There may be unchangeable parts of the structure that will be used as audit and verification component of the chain, in some embodiments.

The foundation of architecture and theory of Merkle Trees and blockchain operations for Ethereum are now described.

Merkle trees' primary purpose is to prove the consistency of data, and a Merkle tree is essentially a tree of hashes. Wikipedia defines Merkle Trees more precisely as the following:

“A Merkle tree is a tree in which every leaf node is labelled with the hash of a data block and every non-leaf node is labelled with the cryptographic hash of the labels of its child nodes.”

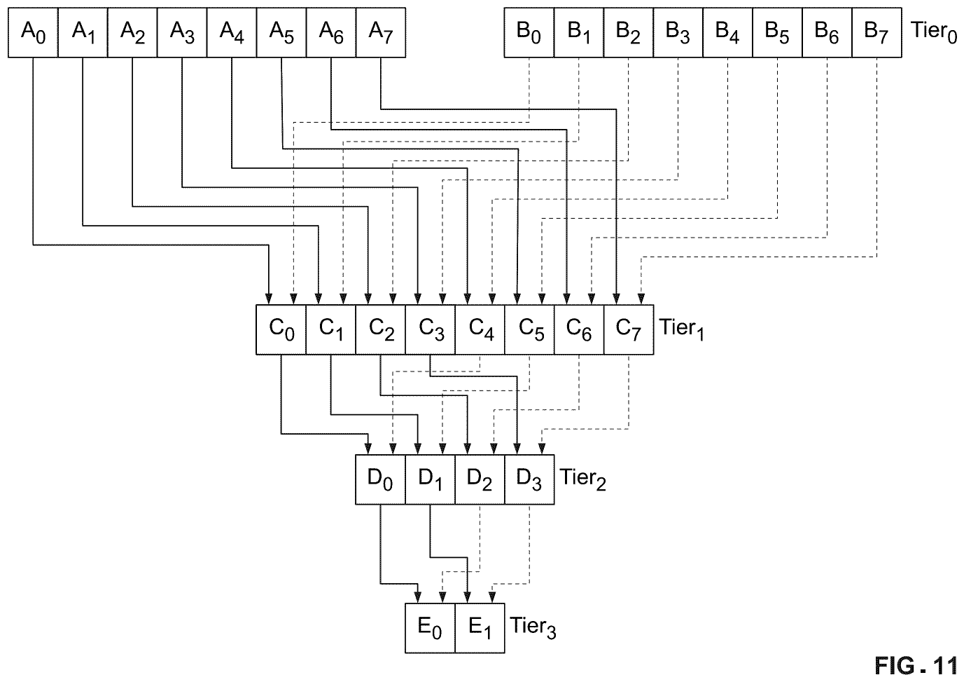

FIG. 11 shows an example of a Merkle Tree, in some embodiments. In some embodiments, data can be held in tier0 in nodes/leaves A0-A7 and B0-B7. Node CX (where X is 0 to 7) can be a hash of a combination (e.g., concatenation) of the hash of node AX and the hash of node BX. Node D0 can be a hash of the combination (e.g., concatenation) of nodes C0 and C4. Node D1 can be a hash of the combination (e.g., concatenation) of nodes C1 and C5. Node D2 can be a hash of the combination (e.g., concatenation) of nodes C2 and C6. Node D3 can be a hash of the combination (e.g., concatenation) of nodes C3 and C7. Node E0 can be a hash of the combination (e.g., concatenation) of nodes D0 and D2. Node E1 can be a hash of the combination (e.g., concatenation) of nodes D1 and D3. And node F0 can be a hash of the combination (e.g., concatenation) of nodes E0 and E1.

This process of re-hashing the combination/concatenation of the nodes to create another node is performed until the a root of the tree is reached, called the ‘root hash’ (e.g., F0), in some embodiments. In this way, Merkle Trees provide a means to prove the integrity and validity of data, in some embodiments.

For example, if we were to change the value of a data block, the entire path leading to the ‘root hash’ would also be changed, in some embodiments. Therefore, if we hold the value of the root hash, we could verify the consistency of data by rebuilding the trie to get the root hash and then compare it with the root hash value in which we are holding, in some embodiments.

In some embodiments, benefits of Merkle Trees include: Data Consistency/Verification; Merkle Tree proofs are computationally easy and fast; and Merkle Tree proofs require only a small chunks of data to be broadcasted across a network.

In some embodiments, in certain distributed systems, data exists in multiple locations; if some piece of data is modified in one location, those changes need to be reflected everywhere else, in some embodiments. Merkle Trees can be used to verify the data and make sure the data is the same everywhere, in some embodiments. As described earlier, this can be done by sending a hash for comparison, in some embodiments. Consider the below sequence that can be between two computers in some embodiments:
1) Computer A sends a hash of the file to computer B.
2) Computer B checks that hash against the root of the Merkle tree.
3) If there is no difference, we're done! Otherwise, go to step 4.
4) If there is a difference in a single hash, computer B will request the roots of the two subtrees of that hash.
5) Computer A creates the necessary hashes and sends them back to computer B.
6) Repeat steps 4 and 5 until you've found the data block(s) that are inconsistent. It's possible to find more than one data block that is wrong because there might be more than one error in the data.

The above sequence illustrates how Merkle Trees facilitate data verification across a network, in some embodiments. To clarify, we are only sending the hash of the leaf that was identified as changed over the network, in some embodiments. The importance of this is that it allows nodes in a distributed system to quickly and efficiently identify data that has changed without having to send over all the data in order to make the comparison, in some embodiments. It's possible to achieve data verification and consistency without the use of Merkle Trees, but to do so might be time-consuming and computationally intensive, requiring the network to check the entirety of each piece of data whenever nodes in the network request to verify data, in some embodiments.

In Ethereum, Merkle proofs make it easy to verify the inclusion of a transaction and enable SPV (simple payment verification). Furthermore, now we have the ability to utilize light clients on the network, as nodes are no longer required to a hold a copy of the entire chain, in some embodiments. In some embodiments, light clients can receive the block headers which contain a Merkle root that can be used to query full nodes to verify if a transaction is included in a particular block. However, full nodes may still be required to maintain a complete list of transaction and update their local state accordingly, in some embodiments.

Ethereum used these trie data structures and their benefits, specifically radix trees and Merkle trees to create an environment to make a sharable secure ledger for transactions of any type.

Ethereum's trie data structure implementation is different than traditional trie implementations, as modifications have been made to increase the performance and efficiency, hence Modified Merkle Patricia Trie.

Merkle Patricia tries provide a cryptographically authenticated data structure that can be used to store all (key, value) bindings. They are fully deterministic, meaning that a Patricia trie with the same (key, value) bindings is guaranteed to be exactly the same down to the last byte and therefore have the same root hash, provide the holy grail of O(log(n)) efficiency for inserts, lookups and deletes, and are much easier to understand and code.

To summarize, tries are cryptographically secure, and each node is referenced by its hash, which is used for lookups in a Leveldb database (Go-Ethereum, CPP-Ethereum, Py-Ethereum) or RocksDB (Parity). In this structure, root nodes become a cryptographic fingerprint of the entire data structure, achieving optimal efficiencies for inserts, lookups and deletes. These tries are stored in a Leveldb instance for Ethereum's Go, C++ and Python clients. Below is a brief description of Leveldb and some of its features.

Leveldb is an open-sourced Google key-value storage library which provides a variety of cool features that include but are not limited to: Data is stored and sorted by keys; Callers can provide a custom comparison function to override the sort order; Ordered mapping from string keys to string values; Multiple changes can be made in one atomic batch; Forward and backward iteration is supported over the data; and Data is automatically compressed using the Snappy compression library.

Trie: In computer science, a trie, also called digital tree, radix tree or prefix tree, is a kind of search tree—an ordered tree data structure used to store a dynamic set or associative array where the keys are usually strings. Unlike a binary search tree, no node in the tree stores the key associated with that node; instead, its position in the tree defines the key with which it is associated. All the descendants of a node have a common prefix of the string associated with that node, and the root is associated with the empty string. Keys tend to be associated with leaves, though some inner nodes may correspond to keys of interest. Hence, keys are not necessarily associated with every node.

In accordance with some embodiments, the following terms are used with reference to Merkle Trees:

Branch: A N-item structure whose first N−1 items correspond to each of the N−1 possible nibble values for the keys at this point in their traversal. The Nth item is used in the case of this being a terminator node and thus a key being ended at this point in its traversal.

Extension: A two-item structure whose first item corresponds to a series of nibbles of size greater than one that are shared by at least two distinct keys past the accumulation of nibbles keys and branches as traversed from the root. The hex-prefix encoding method is used and the second parameter to the function is required to be false, in some embodiments.

Leaf: A two-item structure whose first item corresponds to the nibbles in the key not already accounted for by the accumulation of keys and branches traversed from the root. The hex-prefix encoding method is used and the second parameter to the function is required to be true.
Nibble: Hex form of 4 bits (0x1, 0x4, 0xf)

In some embodiments, the VDA-Data Control acts as a ledger for the VDA file transactions. In some embodiments, it is intended to keep track of files added, files updated, files removed as well as track and provide a means for fragmentation tracking and a source of unfragmenting files.

In some embodiments, the VDA-Data Control can be considered a File Directory as used in NTFS (New Technology File System) of Windows that keeps track of the files on the Windows disk drives. The VDA file system provides utilities and processes that ensure the integrity of the structures that control files contained in the VDA Store, in some embodiments.

In some embodiments, the VDA-Data Control can be based upon Ethereum Blockchain concepts. There is an important difference: while other blockchains may never ‘forget’ any data item linked to them, since the VDA-Data Control is meant to control files, portions of data linked to a chain used herein may change, be deleted or otherwise be altered by operations that occur after the initial insertion, in some embodiments. While the VDA-Data Control may never forget a file, the contents can be altered or removed. This means that GDPR (General Data Protection Regulation) requirements for auditing that data owners requesting that data be forgotten (removed) can be tracked by auditing records that comply with the regulation, in some embodiments.

The structure of the VDA-Data Control can be like blockchains in that the connection or links are intended to be hashes that will help obfuscate and protect the contents of the VDA-Data Control from being altered or otherwise corrupted, in some embodiments. The VDA-Data Control can be used as the method of coordination between all the VDA products to be implemented, in some embodiments.

The use of hash links between items within the database can aid in ensuring the integrity of the VDA-Data Control, in some embodiments. Since the VDA-Data Control holds the key to reassembling the fragments, it can becomes especially important to protect that information in the database, in some embodiments. As such, it may be desirable to use strong encryption methods within the database, in some embodiments. However, the information may need to be able to be read from any internet access point if the user authentication credentials are presented, in some embodiments. This may require the key or certificate used as input to any encryption algorithm to be based upon the user selected access authorization information they used when the application is installed, in some embodiments. This may require the generation of a ‘secret’ that can be reproduced by a combination of user credentials and select other data that is consistent between installations, in some embodiments.

The folders and files of the VDA-Data Control database may need to be owned only by VDAManager and access granted to VDAAccess and the Group VDAStorm, in some embodiments.

A ‘hashed’ secret from the user authentication data may be created and used as part of the keys used to encrypt the data in the database, in some embodiments. The simplest method would be to use the AES-256 symmetric algorithm, in some embodiments. It is considered a strong algorithm and the key could be created from known sequence of numbers common to all VDA installations, in some embodiments. This may need to be a large number (in alphanumeric form), preferably, a large prime number, in some embodiments. This may be mathematically combined with the user authentication values to create a reproducible encryption key to lock and unlock the data contained in the VDA-Data Control, in some embodiments. The method may need to be verified as secure during QA oversight, in some embodiments.

In some embodiments, an asymmetric algorithm can be used (PGP, RSA, etc.) if a reliable method of combining the user authentication values with a source of an easily input key pair is available. A crypto certificate bound into the installer can be used as a basis for this, in some embodiments. However, this may have to be verified as a secure method of protecting the VDA-Data Control, in some embodiments. In some embodiments, possibilities that could serve as inputs to the algorithm include: License Key Credentials; PGP/GPG key pair shared to public directory; RSA key pairs if available; X.509 certificates from services.

The VDA-Data Control can uses Merkle Chain Trees to connect all the control structures for the files contained in the VDA Store, in some embodiments. This is based upon the concepts of Blockchains and the Ethereum ‘flavor’, but does differ in several aspects, in some embodiments.

In some embodiments, VDA-Data Control Root Control Block (RCB) can be the first entry in the VDA-Data Control and can used to link to the stored settings and state control of the application. These are the settings that control the user interface, defaults, performance throttling, security, and so on, in some embodiments. The content linked via hashes is described below, in accordance with some embodiments. The root link can also have the link that points to the first file link, in some embodiments.

In some embodiments, the VDA Store Settings segment holds the settings of the VDA Store. In some embodiments, these parameters can be used to control the overall actions of the VDA Store for the application: VDA Store Name; VDA Store UUID (Universally Unique IDentification); VDA Store Owner; Drive Setting Links; Deletion Delay (Time Period to hold file after user request to delete it; File is held in cache until time period expires; In directory displays, the file may be highlighted by a difference color (e.g., orange); the FCB state is set to “marked as deleted”); Airplane Mode—Allows access to files when PC has no network connections (Airplane holds all file fragments locally for an identified set of files in the Offline Storage Folder in % APPDATA % folder); Airplane Mode Period (Time Period to remain in Airplane Mode Once Activated; Zero indicates to remain in Airplane until canceled by User); Timestamp of creation; Timestamp of modification; Total Storage Assigned; Total Storage Available; Total Storage Used; Total File Count; File Statistics by Type (extension); Count of Files; Storage Used By Files; Timestamp last file added; Timestamp last file deleted; Timestamp last file modified; and/or any other suitable parameter(s).

In some embodiments, VDA may have several dashboards to display summary status for such elements as: Status of the VDA Store; Status of VDDs; Status of Storage Sources; Status messages from VDA; Display performance monitors of consumed resources; Display settings, defaults; and/or any other suitable dashboard(s).

In some embodiments, the dashboard options may include being able to: Alter color of backgrounds, font color, font size and resize windows; Add or subtract optional display components; Specify default startup display; Default export data format and location for dashboard data; and/or any other suitable option(s).

In some embodiments, there are settings for the defaults used to create a basic setup for the user. These settings may also hold the last setting used for inputs when setting up VDA Store controls, drives, and storage locations, in some embodiments. The user can alter these defaults to what their situation warrants, in some embodiments.

In addition, this area of the VDA-Data Control may also store the last used inputs to act as helpful prompts in input forms, in some embodiments.

The VDA Store may be used to recover data possibly lost due to a PC or notebook computer drive failure or possibly recover data from stolen computers or drives (any data lost via this way will be protected by fragmenting and encrypting), in some embodiments. In some embodiments, the user may be required to establish at a minimum a user ID and password and, preferably, a Two-Factor Login configuration for VDA Store access. This may allow the user or users to login at another PC with VDA installed or, later, when the VDAServer or VDACloud and connect to the VDA Store allowing access to their data, in some embodiments. This assumes they have established authorized connections to the various cloud services where their data was stored, in some embodiments.

In some embodiments, this VDA-Data Control section may contain data such as: Authorized Devices (an authorized device may be able to be used to validate other devices to be used and have a simpler login authentication process); Device Name; Device UUID; Device Serial ID; Device MAC address; Last used timestamp; First user timestamp; User credentials (User ID (Email, Username, etc.), User Display Name, User ID Hash, Password); Emergency recovery information; and/or any other suitable data.

In some embodiments, this VDA-Data Control segment can define limits for resources that VDA can use of the PC. In some embodiments, these may be divided into types of resources and detailed as follows: CPU Process Settings (e.g., Real Time; High; Above Normal; Normal; Below Normal; Idle/Suspended; FPU; Maximum Parallel Threads); GPU Process Settings (e.g., Maximum Parallel Threads; Maximum Operating Temperature; Memory); Process Limits (e.g., Normal; Below Normal; Medium; Low; Very Low); Cache (VDABuffer in Memory) (e.g., Minimum Cache Pool Size, Maximum Cache Pool Size, Pool Block Segment (size of blocks for storing file segments), Pool Allocation Block Size (size of memory expansion when expanding)); Cache (VDA Page on Disk Paging) (e.g., Initial Disk Cache Size, Maximum Disk Cache Size, Cache Request Block Size (size of blocks for storing fragments), Cache Allocation Block Size (amount allocated when expanding), I/O); Process Settings (e.g., High, Normal, Low, Very Low); Throughput Settings Per Drive/Location (e.g., IOPS (Input/Output Operations Per Second), MEPS (Megabytes Per Second), Network (Per Interface)), Maximum Network Sessions, Maximum Transmission Rate (MB/s), Maximum Reception Rate (MB/s), Maximum Collisions Per Second; File Paging/Caching Controls; Maximum Active Files; Days File is considered Active; Maximum Parallel Store Actions; Maximum Parallel Retrieve Actions; Monitor Controls; Data Collection Cycle (in minutes); Maximum days of details to store; Email Address to transmit reports to (optional); Email Account authentication information; Email report frequency; Mass File Change Limits (per connected storage points); File Changes per Day; File Changes per Hour; File Changes per Minute; File Changes per Second; and/or any other suitable limit(s).

The VDA_WatchACP service is the process that uses the limits defined in this section to control the performance of VDA, in some embodiments.

The VDA-Data Control Drive Settings may be linked to the storage resources defined in this VDA-Data Control segment, in some embodiments. This area can contain the results of scanning (and manually added by the user) for storage resources on and connected to the PC, in some embodiments. This section can also contain the limits and other controls that are defined by the user upon VDA to govern the use of storage resources, in some embodiments. In some embodiments, these settings can include: Storage Resource Name (Per storage resource); Storage Resource UUID (Universally Unique IDentification); Storage UID from Hardware or generated ID from provider; Storage Resource Owner; User Name; Password; Possibly other token method to access given storage resource; Storage Resource Specific Controls such as Geographical, Time Limitations, and/or any other suitable controls; Timestamp of creation; Timestamp of modification; Total Storage Assigned; Total Storage Available; Total Storage Used; Total File Count; File Statistics by Type (extension); Count of Files; Storage Used By Files; Timestamp last file added; Timestamp last file deleted; Timestamp last file modified; and/or any other suitable setting(s).

The Drive settings segment can link the storage areas to the VDA Store Segment, in some embodiments. This segment can have the controls for the management of the VDDs of VDA, in some embodiments. In some embodiments, these settings can include: Drive Resource Name (Per Drive resource); Drive Resource UUID (Universally Unique IDentification; Drive Resource Assigned Letter; Drive Resource Owner; Default Encryption Method; Drive Resource Notes (e.g., an area for user to comment about drive and its uses, limitations, etc.); Storage Resources Control (per storage resource); Timestamp of creation; Timestamp of modification; Total Storage Assigned; Total Storage Available; Total Storage Used; Total File Count; File Statistics by Type (extension); Count of Files; Storage Used By Files; Timestamp last file added; Timestamp last file deleted; Timestamp last file modified; Drive Filters (e.g., Parameters that control what files are stored on this drive); By Type (e.g., Default Setting is: *—All Types); Inclusive list: doc; txt; jpg (File Types to Include); Exclusive list: -doc; -txt; -jpg (File Types not to include); File Size Filter (e.g., Smallest File Allowed (Kilobytes) KB; Largest File Allowed (Kilobytes) KB); Versioning (e.g., Default number of versions to retain on this drive, May be overridden by file settings, Version Count: 2—This keeps the current version of the file and one back, Purge Cycle: 2 Days); A process run every X days to remove versions in excess of settings in the FCB; Drive Control; Initial VDA Page Size; Maximum VDA Page Size; Maximum VDA Page File Count; Initial VDABuffer Size; Maximum VDABuffer Size; Maximum VDABuffer File Count; and/or any other suitable setting(s).

This VDA-Data Control segment can have the controls that manage the VDA Page storage for cached or active files, in some embodiments. This file on the local PC can serve as the holding area for assembled (from the fragments) files that are active (open by the user) and can also be used to queue files being stored into the VDA Store, in some embodiments. The files here can be identified only by hashed UUIDs (an indexed value) from the File Control Block, in some embodiments. The VDA Page storage can act like the Windows Paging File, in some embodiments. It may be possible to implement this function of VDA using the memory page file functionality of Windows API libraries, in some embodiments. Additional storage may need to be allocated for the VDA Swap file which holds the metadata retrieval information for active or queued file within the VDA Store, in some embodiments. The combination of the VDA Page and VDA Swap files is denoted as the Queue Control Pool (QCP), in some embodiments.

This storage area can also serve as the work queue for VDA, in some embodiments. Besides holding the active files, this segment can also hold the files being VDAd and those being unVDAd, in some embodiments. This can allow VDA to resume processes in progress after an unexpected interruption in operation, in some embodiments.

The QCP, by default, can be setup to be allocated on all local drives, in some embodiments. The initial setting can be for the QCP to allocate 5% (or any other suitable amount) of the free space on the local drives with a maximum expansion to 10% (or any other suitable amount), in some embodiments. The default settings can be overridden during installation or after installation via the User Settings Dialog, in some embodiments.

In some embodiments, the QCP settings can include: VDA Page (e.g., initial Page File Size in Gigabytes (GB)); Initial setting calculated from free space on local connected drives; 4% of Free Space on Drives (e.g., Maximum Page File Size in GB); Calculated during install; 8% of Free Space on Drives; Expansion Size in Megabytes (MB) (e.g., Default is 1000 MB); Allocation Block size in bytes (e.g., 4096 bytes (default sector size of NTFS Volume)); Maximum Loaded Fragments per File (e.g., 64); VDA Swap; Initial Page File Size in Gigabytes (GB) (e.g., Initial setting calculated from free space on local connected drives, 1% of Free Space on Drives); Maximum Page File Size in GB (e.g., Calculated during install; 2% of Free Space on Drives); Expansion Size in Megabytes (MB) (e.g., Default is 256 MB); Allocation Block size in bytes (e.g., 2048 bytes); and/or any other suitable settings.

The Queue Control Pool status can be monitored and be able to be examined via a dashboard, in some embodiments. The WatchDog_ACP may monitor the Queue Control Pool and issue alerts when the pool may run out of space, in some embodiments.

The Cache Control segment can hold the controls for the memory buffer that holds the active file content the user, in some embodiments. This area of memory can be mapped onto VDADrive and accessed as files by the user, in some embodiments. The VDABuffer can hold three (or any other suitable number) areas for each file, in some embodiments. A prior area (data ‘before’ what the user is currently accessing), an active area (data the user is currently accessing), and a next area (data the user is likely to access) can be provided, in some embodiments. In some embodiments, this is basically a pipeline stream concept used by many editors to access large data files.

In some embodiments, the Cache Control Pool settings can include: Initial Pool Size in Megabytes (MB); Maximum Pool Size in MB; Growth size in GB; Allocation Block size in bytes; and/or any other suitable settings.

The Cache Control Pool status may be monitored and be able to be examined via a dashboard, in some embodiments. The WatchDog_ACP may monitor the Cache Control Pool and issue alerts when the pool may run out of space, in some embodiments.

The User Access Block can control and manage multiple users accessing a given VDA Store's VDDs, in some embodiments. For example, this can be used by a small to medium business where multiple users access common storage on another PC or possible server, in some embodiments. In this case, there may be multiple user accessing the same VDDs each with their own credentials (and 2FA) possibly using the same set of encryption keys and method on the common storage, in some embodiments.

Other linked information of the VDA-Data Control can be file management linked information, in some embodiments. This set of information can be used to control and manage the files in the VDA Store, in some embodiments. The information required to do this can be contained in several linked structures to the VDA-Data Control which are explained below, in some embodiments. In addition, there may be reference control blocks that can be used to contain auditing information, crypto control, access control lists, user authentication credentials, and/or any other suitable informations, in some embodiments. In some embodiments, the links between blocks (table entries) can be hashed to allow the linkage within the database to be easily verified and also ‘hide’ the relationship between elements of the database from unauthorized viewing, in some embodiments. The contents of the control blocks may also be encrypted with the VDA ‘secret’ key to protect the contents, in some embodiments.

In some embodiments, the Root Control Block can be an anchor table within the VDA-Data Control database. This block can link other control blocks along with settings for the VDA product, in some embodiments. In some embodiments, the RCB can include: VDA Store Settings; Dashboard Settings; Defaults; User Access Control Links (UAB); Two Factor Authentication credentials; Performance Controls; Storage Control Links (SCB); Drive Control Links (DCB); Queue Controls (VDA Swap, and VDA Page settings); Cache Controls (VDABuffer settings); and/or any other suitable information.

The Storage Control Block can contain settings and controls for each storage location within the VDA Store, in some embodiments. These blocks can be created during setup of VDA or when the user adds a new storage location to the VDA Store, in some embodiments. These control blocks can hold the information necessary to access the storage location, plus limit and control access to the storage location per user requirements, in some embodiments. In some embodiments, the SCB can include: UUID for SCB; Timestamp(s) (e.g., VDA Store (Stored; Retrieved; Modified; Deleted); Windows (Created; Modified; Accessed; Printed)); Status (status should have an Audit Control Block entry to ‘explain’ status) (e.g., Active, Disabled, No Access, Authentication Failure, Removed, Storage Space Issue); User Authentication Controls (access to the storage location); Storage Type (should model Windows storage types) (e.g., Local Drive; USB Drive; Memory Card; Mapped Drive; Network Drive; NAS; SAN; Cloud Service; Storage Name/Provider; Storage Quotas); Provider Specific Controls (e.g., Geolocation; Tenanted Storage; Folder specific); UAB Links (e.g., Additional User Access Credentials); CCB Links (e.g., Encryption Controls); ACB Links (e.g., Audit trail for activity); Next SCB; and/or any other suitable information.

The Drive Control Block can contain the definitions for the VDADrive(s) for the system, in some embodiments. A user may define one or several drives for their PC, in some embodiments. Each VDADrive may have different storage location definitions and/or filters applied to that particular drive, in some embodiments. The DCB can also be the top of defining storage hierarchy for the VDADrive, in some embodiments. Depending upon user setup, the root of the drive may have just folders or just files or a combination of both, in some embodiments. The DCB can mimic a regular windows directory on any given drive, in some embodiments.

In some embodiments, the DCB can include: Drive Name; Drive Letter Designation; UUID for Drive; Timestamp (e.g., VDA Store (e.g., Stored, Retrieved, Modified, Deleted); Windows (e.g., Created, Modified, Accessed, Printed)); SCB Link List (e.g., Storage Locations); FoCB Link List (e.g., Folder Control Block List); FCB Link List (e.g., File Control Block List); Next DCB; Compression Settings; Drive State (e.g., Normal, Active, Verifying, Offline); ACB Link; ACL Link; CCB Link; and/or any other suitable information.

The Folder Control Block can hold the definitions and controls for folders within the VDADrive, in some embodiments. A given FoCB may contain links to files or folders or a combination of both, in some embodiments. This can operate just like a regular windows drive, in some embodiments. In some embodiments, the FoCB can include: Folder Name; UUID for Folder; FoCB Link List; FCB Link List; Version Limits; Timestamp (e.g., VDA Store (e.g., Stored, Retrieved, Modified, Deleted); Windows (e.g., Created, Modified, Accessed, Printed)); Next FoCB; Compression settings; State; ACB Links; ACL Link; CCB Link; and/or any other suitable information.

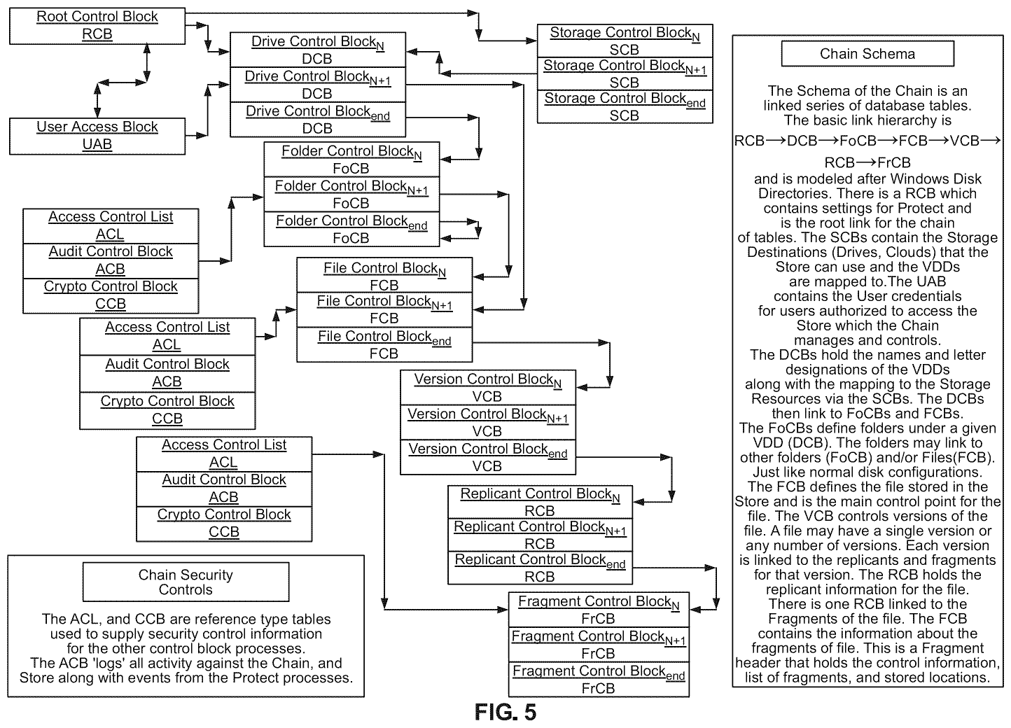

The FCB can be a control structure for files stored in the VDA Store, in some embodiments. It can be the top of the file hierarchy structure in the VDA Store, in some embodiments. The File Hierarchy can have FCBs->VCBs->ReCBs->FrCBs linked as shown in FIG. 5 (which shows the ReCBs as RCBs), in some embodiments. In particular, in some embodiments, the FCB can include: Filename; UUID (Universally Unique IDentifier); Timestamp (e.g., VDA Store (e.g., Stored, Retrieved, Modified, Deleted); Windows (e.g., Created, Modified, Accessed, Printed)); File Source Location/Name (e.g., The original File Location and Filename); Origin device info; Network info; Unique ID of Device; Common Identifier; Original Owner (e.g., Owner ID, SID from PC, Owner Group, Owner Group SID); All IDs granted access; Original ACL (e.g., ACL from original file, Auditing settings from original file); Version Limit (e.g., The maximum count of prior versions kept, Zero (0) keeps no prior versions); VCB Link; Compression (e.g., Compression On/Off, Compression Algorithm); State (e.g., File State (e.g., Active, Deleted, Stored, In Retrieval, Being Stored, Being Updated); Version State; Number of Active Versions; Last Version Created; Replicate State (e.g., Number of Active Replicates; Last Replicate Update); Verification State; File Total Size in bytes; File Structure Last Verified; File Structure Last Fully Validated; Small File Indicator; ACB (Audit Control Block) Link; Hash link to ACB; and/or any other suitable information.

The ACB may also contain an entry that has the hash value of the file contents to verify VDA Operations; ACL (Access Control List) Link; Hash Link to ACL; CCB (Crypto Control Block) Link (e.g., Hash Link to CCB); and/or any other suitable information, in some embodiments.

The Version Control Block can be used to manage versions of the data stored in the VDA Store, in some embodiments. The user may specify the number of versions of the data that is kept, in some embodiments. A version may be created when: Data is stored in the VDA Store; Data is modified; Data is deleted; At the user's request; and/or at any other suitable time, in some embodiments.

For each version, a complete set of replicates and fragments may also be kept, in some embodiments. Versioning can serve several rationales, in some embodiments. The first can be allowing a user to recover from data updates that were committed in oversight, in some embodiments. The second can be to protect the data from malicious activity such as attempted data corruption or crypto ransomware attacks, in some embodiments.

In some embodiments, the version control block can include: File UUID; Version Number; UUID of Version; State; Timestamp(s) (e.g., VDA Store times (e.g., Stored, Retrieved, Modified, Deleted); Windows times (e.g., Created, Modified, Accessed, Printed)); Next VCB; Replicant Limit; File Size; Hash Value; ACB Link; ACL Link; CCB Link); and/or any other suitable information.

The Replicate Control Block can hold the information to manage the replicated copies of the data in the VDA Store, in some embodiments. Each replicate block can have connections to the other replicate blocks and the links to the chain of fragments that compose the replicate of the data, in some embodiments.

In some embodiments, the replicate control block can include: File UUID; VCB UUID; Replicate Number; Replicate UUID; Timestamp(s) (e.g., VDA Store times (e.g., Stored, Retrieved, Modified, Deleted); Windows times (e.g., Created, Modified, Accessed, Printed)); State; Next ReCB; Fragment Limit; Version Limit; Encryption Type; UAB Link; ACB Link; ACL Link; CCB Link; and/or any other suitable information.

The Fragment Control Block can hold information that links the fragmented prices of the file, in some embodiments. Although the fragments themselves can hold the necessary information to relink themselves, in some embodiments, the FCB can enable rapid reassembly and location of file fragments as they are scattered throughout the VDA Store, in some embodiments. In some embodiments, the FRCB and include: FCB UUID; Filename; UUID; Timestamp(s) (e.g., VDA Store times (e.g., Stored, Retrieved, Modified, Deleted); Windows times (e.g., Created, Modified, Accessed, Printed)); VCB UUID; Version Number; ReCB UUID; Replicant Number; Compression Method; State; First Fragment Hash Link; Fragment Count; Fragment Hashed Link List; and/or any other suitable information.

The User Access Block can be the holder of authentication information needed to access resources of the VDA Store, in some embodiments. This can be for a particular VDADrive or for other resources that may need credentials for user-based access, in some embodiments. In some embodiments, the UAB can include: VDADrive DCB UUID (optional); User Credentials; Two Factor Credentials; Next UAB; and/or any other suitable information, in some embodiments.

The ACL can be a simple structure, in some embodiments. Beyond the links back to the source Control Block, the ACL can be an implementation of the Microsoft Windows ACL hierarchy methods, in some embodiments. This can be done for compatibility with Microsoft ACL implementations to allow easy merging and exchange of policy with Servers and Active Directories, in some embodiments.

In some embodiments, the ACL block can include: Timestamp(s) (e.g., VDA Store times (e.g., Stored, Retrieved, Modified, Deleted); Windows times (e.g., Created, Modified, Accessed, Printed)); Status; ACE (Access Control Entry); and/or any other suitable information. The rest of the ACL block can be links to ACE entries that define allowances or limits to access to the file by user, groups, location and so on, in some embodiments. This can be the same as the Microsoft Windows ACL/ACE structures, in some embodiments.

The following references are hereby incorporated by reference herein in their entireties:
https://docs.microsoft.com/en-us/windows/desktop/secauthz/access-control;
https://espace.cern.ch/winservices-help/NICESecurityAndAntivirus/NICESecurityHowTo/Documents/ACL_helpPage_v1.0. pdf;
https://compas.cs.stonybrook.edu/-nhonarmand/courses/fa14/cse506.2/slides/ACLs-Vasu_and_Yaohui.pdf; https://docs.microsoft.com/en-us/windows/security/identity-protection/access-control/access-control.

The audit control block tracks the activity and actions that are performed on the file stored in the VDA Store. The purpose of this structure is akin to the event logs in the Windows Operating System. This structure is intended to be immutable along with the FCB top hierarchy block and the Merkle chain link. This allows the tracking of the file's ‘life’ from inception to removal. This ability to track a file activities at this level (in particular who accessed it, etc.) becomes important when providing logs to users about how their data has been used in commercial settings. This is particularly applicable to the GDPR (General Data Protection Regulation) and those rules and laws similar to it that have a required ability to track deletion of a user's data (the Right to Be Forgotten). The ACB will enable the ability to audit such requested deletions easily.

In some embodiments, the ACB can include: ACB Master Block; Hashed Link back to FCB; UUID for ACB; Timestamp(s) (e.g., Created; Modified; Accessed; Printed); Last File Action; Coded entry to reference table of audit actions; Last Status of File; Coded entry to reference table; Last User ID; Last User ID to access file; Geolocation track; Last Geolocation info to access file; PC ID information; Hashed link to first Audit Control Entry with details; Hashed link to last Audit Control Entry with details; Audit Control Entries; Hashed Link back to ACB; Hashed Link to Prior Audit Entry; Hashed Link to Next Audit Entry; UUID for Audit Entry; Timestamp(s) (e.g., Created; Modified; Accessed; Printed); File Action; Coded entry to reference table of audit actions (This is an initial list); Authenticate User; Add User; Remove User; Freeze User; Add File; Add File Version; Alter File Version Settings; Purge Old File Versions; Retrieve Specific Version; Encrypt File; Decrypt File; Alter Fragmentation Settings; Retrieve File; Delete File; Verify File; Deep Verify File; Verify VDA-Data Control; VDA-Data Control Integrity Check; Rebuild VDA-Data Control; Add Storage Location; Remove Storage Location; Transfer Storage Location; Modify Storage Location; Add VDADrive; Remove VDADrive; Modify VDADrive; Add Local PC Access; Remove Local PC Access; Transfer Local PC Access; Utilities; VDA-Data Control Scan; VDA-Data Control Verify; VDA-Data Control Recovery; VDA Reassemble; Status of File (e.g., Active; Deleted; Stored; In Retrieval; Being Stored; Validated); User ID; Geolocation tracking; Location of activity; By IP Address; By GPS input; PC ID information; MAC Address; IP Address; External and Internal; Router/Gateway information; UIDs from PC Hardware; Other UIDs from attached hardware; Status/Action Details; attached information relevant to action recorded (e.g., this could be a crash listing, output from VDA routines, etc.); and/or any other suitable information.

The Crypto Control Block can contain encryption information for the file described in the FCB, in some embodiments. This may be a critical information area of the VDA-Data Control and may have protection against unauthorized access to the data contained within it, in some embodiments. The CCB can holds the information necessary to encrypt and decrypt the fragments of the file stored in the VDA Store, in some embodiments. This does not mean the storage of any keys, however, depending upon what algorithms are chosen, what is stored could be used as a starting point to penetrate the encryption used on the file and/or the VDA Store, in some embodiments. In some embodiments, the CCB can have a simple usage. In some embodiments, the user may be able to specify multiple encryption methods to be used for each replicate of a file stored in the VDA Store.

In some embodiments, the CCB can include: UUID for CCB; Crypto Master Key; Link to Master Crypto Key store for encryption of VDA components; Encryption Certificates; Location of encryption certificates on PC; User Certificates; Location of user specific certificates; Encryption Control links; Hashed Pointer to Encryption Block; Encryption Method; Use Filter; Default; By VDADrive; By Storage Location; By File Type; By Replicate; Hashed pointer to keys, etc.; and/or any other suitable information.

The fragment blocks can be the holders of the actual data being stored in the VDA Store, in some embodiments.

These data shavings can be split apart pieces of the whole data file which can also be encrypted plus compressed, in some embodiments. This combination of data manipulation methods layered on top of one another can make it very difficult for an unauthorized user to access the data without having an authenticated and authorized access, in some embodiments. It may be a requirement of data stored in the header information to be able to reconstruct the data file without the VDA-Data Control, in some embodiments. This may enable the user with the proper access to storage locations that make up the VDA Store, the crypto keys, and compression passwords to rebuild the data file from the fragments, in some embodiments.

When the file is fragmented and the fragments stored across the VDA Store, a method of dispersion and tracking of the dispersed fragments may be employed, in some embodiments. Each VDADrive can have a set of connected storage locations as defined by the user at installation or creation of the VDADrive, in some embodiments. The fragments for each replicate can be dispersed into separate locations making sure the same numbered fragment from a given replicant are not stored in the same storage location, in some embodiments.

In order to minimize the effect of sector waste or ‘slack space’ when storing small files, the file fragments can be optimized to 4K sizes (or any other suitable size), in some embodiments. The default size for sector allocation on Windows NTFS drives is 4096 bytes and VDA may attempt to optimize usage of the disk space as much as possible, in some embodiments. In some embodiments, files can be constructed to have as little slack space as possible to optimize both space usage and disk I/O performance.

Each fragment file may be named uniquely and in a way that cannot via any method be used to aid in reconstituting the entire file, in some embodiments. In some embodiments, the only methods of reassembly may be via the FrCB or via the utilities provided to access the fragments with the correct credentials provided. Given the requirements for the filename of each fragment, in some embodiments, file fragment naming can include: Calculating MD5 Hash of File Fragment; Calculating MD5 Hash of File Fragment UUID; Adding the two hash values together; Selecting the resultant value as the file name with the extension .fgg; and/or any other suitable operations.

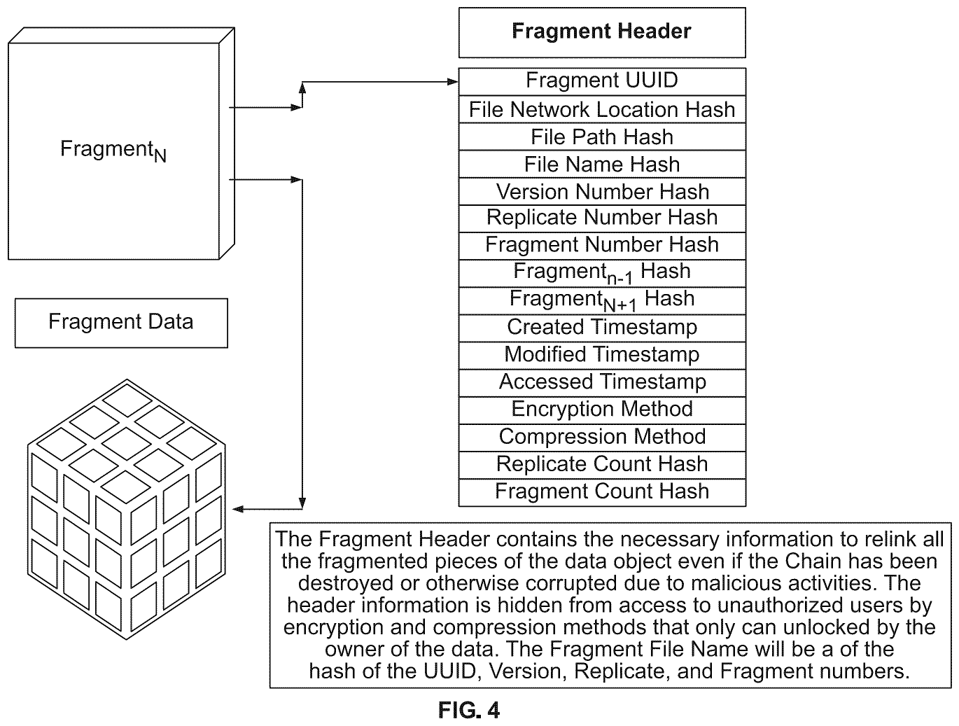

In some embodiments, as shown in FIG. 4, the header contains the information that allows the fragment to be linked together with the other fragments that comprise the whole data object. In some embodiments, the header is not compressed or encrypted according to user specifications, however the data contained within header is encrypted and hidden via reversible hash methodologies to hide the data from unauthorized access. In some embodiments, the header of the data fragment may contain: UUID; Source File Network Location (hashed); Source File Path (hashed); Source Filename (hashed); Version Number Hash; Replicate Number Hash; Fragment Number Hash; FragmentN−1 Hash; FragmentN+1 Hash; Created Timestamp; Modified Timestamp; Accessed Timestamp; Encryption Timestamp; Compression Method; Replicate Count Hash; Fragment Count Hash; and/or any other suitable information.

The data portion of the fragments of the VDA Store may be the ‘cut up’ pieces of the data file that was placed on a VDADrive by the user, in some embodiments. In some embodiments, the file can be cut up based on a specified number of fragments divided into a file total size. This may be the basic method for small files this is altered to ensure the data is obstructed from simple viewing of the fragment, in some embodiments. The data may be fragmented and placed in the VDABuffer and VDA Page subsystem storage, in some embodiments. The ACP services of VDA may then create the VDA-Data Control entries, the Fragment Headers and store the new VDAd file according to the VDADrive configuration settings in the VDA Store, in some embodiments.

The VDA-Data Control may be a key component of VDA that manages and tracks the fragmentation of files, the reassembly of the files, and the main management point of security for the application and the files, in some embodiments.

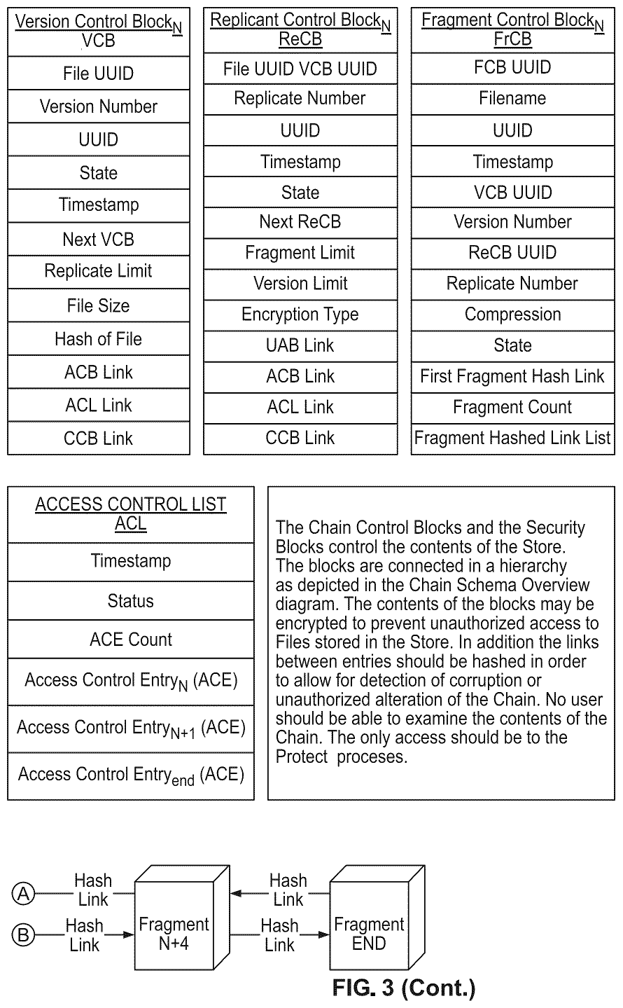

FIG. 3 illustrates an example of a chain control blocks in accordance with some embodiments. The chain control blocks and the security blocks can control the contents of the store, in some embodiments. The blocks can be connected in a hierarchy as depicted in the FIG. 5, in some embodiments. The contents of the blocks may be encrypted to prevent unauthorized access to files stored in the Store, in some embodiments. In addition, the links between entries should be hashed in order to allow for detection of corruption or unauthorized alteration of the Chain, in some embodiments. No user should be able to examine the contents of the chain, in some embodiments. The only access should be to the protect processes, in some embodiments.

This schema may implement the VDA-Data Control control blocks as tables within the database, in some embodiments. In some embodiments, the database may replicate its tables over all the locations of the VDA Store to provide the best recovery and availability probabilities for the VDA-Data Control. This may also be needed in order to support the user accessing the VDA Store for other locations other the original PC the VDA product was installed on, in some embodiments.

In some embodiments, the security and integrity of this database may be critical to the operation of the VDA product and the ensuring the availability and integrity of the data stored in the VDA Store. The links within the database may be hashed to hide connections and the entire database be encrypted using strong algorithms, in some embodiments.

In some embodiments, when a file is added to the VDA Store: the ChainACP service may receive information from the VDAACP service and create the initial VDA-Data Control entry for the file; create the Root Merkle chain link; create the FCB; create the ACL; create the ACB (e.g., first entry for File Creation, etc.); create the CCB; create the Storage control chain; create the VCBs; create the RCBs; attach the Fragment Chain; and/or perform any other suitable operation.

In some embodiments, file modifications may create new VCBs when versions are enabled. The sizing fields of the FCB may be updated along with hash links and controls plus the ACB will have a new entry created for the modifications made to the fragments, in some embodiments. The fragment blocks may be updated as necessary from the VDABuffer and VDA Page, in some embodiments. This operation may be the same as when a new file is fragmented and written into the VDA Store, in some embodiments.

When a file is deleted from the VDA Store, the VCB, ReCB, FrCB, ACL and CCB control blocks may be deleted after a deletion delay, in some embodiments. The ACB control block along with the FCB remains may be marked “as deleted”, in some embodiments. It may be possible to ‘undelete’ the file until the deletion delay has expired, in some embodiments. An ACB entry may be created for the deletion request along with an ACB entry, in some embodiments. This can be done via the ‘right-click’ context menu on the file entry in the Windows File Explorer Application, which may also create an ACB deletion request canceled entry, in some embodiments. In some embodiments, once a file is eligible to be deleted, the following may occurs: the Fragment Blocks (FB) are deleted from the VDA Store for all replicants, and versions; once the Fragments are deleted the VCB, ReCB, FrCB, ACL, and CCB blocks are deleted from the VDA-Data Control; the FCB is updated to ‘deleted’ status with the link fields cleared; and the ACB has an entries added, such as an deletion expiration entry, a deletion ACB entry with all appropriate information for auditing, a Date time stamp, PC details (e.g., MAC, SID, Model Serial, etc.), user details (ID, name, location); network details (e.g., IP, Gateway, External IP, ISP info, location, etc.), and/or any other suitable information; and/or any other suitable operations.

In some embodiments, the general rules for any file operation and the VDA-Data Control may be as follows: whatever operation is performed upon the file, an ACB entry must be created in the immutable list of operations performed on that file. The key to following the activities performed on the file is the UUID created when the file is first entered into the VDA Store, in some embodiments. This key always remains the same for the file within the VDA-Data Control, in some embodiments.

VDA may act as another file system on the user's PC, in some embodiments. VDA may initiate at least one VDADrive on the user PC which appears to be another lettered drive on the user's PC, in some embodiments. This can be accomplished by using the Windows Driver Library to create the virtual drive, in some embodiments. Files dropped onto the drive can be stored in the VDA Store according to the settings defined for the drive, in some embodiments. In some embodiments, for certain file types, sizes, and/or other parameters, fragmentation settings can be stated and applied to the group of files. The VDADrive can act like another drive on the system listing files contained on the drive and interacting with File Explorer or applications as a user would expect, in some embodiments.

In order to support this for the fragmented files contained in the VDA Store, the use of paging and caching methods similar to Windows Operating System methods may be applied, in some embodiments. The services of VDA may create the lettered VDDs and then utilize the VDA Page and VDABuffer components to provide the user access to the files, in some embodiments. While the contents of these files may be stored in the VDA Page or VDABuffer sub-system, they should be secured in a manner to prevent unauthorized access, in some embodiments. This may require the paged or cached contents to hashed or encrypted to protect the contents, in some embodiments.

When a file is placed on the VDADrive, a process may begin to fragment the file and optionally compress and encrypt the file to the specified parameters for the drive, in some embodiments.

The process detailed below assumes for this section that the VDADrive has no abnormal statuses or conditions that would prevent the storage of the file into the VDA Store.

In some embodiments, the processing of storing a file into VDA Store may include: a file or files is/are placed on the VDADrive (the VDA may be multi-threaded to allow multiple files to be processed and maintain performance for the user; VDA_VDAACP replicates the file according to settings, uses VDA_CryptoACP to encrypt file per settings and to compress file per settings, and fragments the file according to fragmentation settings; VDA_ChainACP receives information from the VDAACP service and creates the initial VDA-Data Control entry for the file, creates the Root Merkle chain link, creates the FCB, creates the ACL, creates the ACB (First entry for File Creation, etc.), creates the CCB, and creates the Storage control chain (creates the VCBs, creates the RCBs, attaches the Fragment Chain); VDA_StorageACP accepts the fragments of the replicates for storage; the Fragments are stored according to settings for fragmentation; the storage locations and other data required is returned to the ChainACP as each fragment is ‘committed’ to the VDA Store; VDA_CacheACP creates the headers in VDA Page and VDABuffer when the FCB is created; as each Fragment is stored by the StorageACP the CacheACP places the fragment into the VDA Page structure; and the fragments of the start of the file are loaded into the VDABuffer until filled according to settings (these fragments are those attached to the file entry in the lettered VDADrive). Note that VDA_GPUACP may be used to perform CPU intensive operations during hashing, encryption, and compression operations in particular, in some embodiments. This ACP can also be used to any CPU rigorous operation to prevent excessive CPU loading, in some embodiments.

When a file is clicked on from File Explorer or accessed via an application that is on the VDADrive, a process may begin to unfragment the file and optionally decompress and unencrypt the file to the specified parameters for file in the VDA-Data Control, in some embodiments.

The process detailed below assumes for this section that the VDADrive has no abnormal statuses or conditions that would prevent the retrieval of the file from the VDA Store. In some embodiments, the processing of retrieving a file from VDA Store may include the following (as well as any other suitable operations): a file or files is/are clicked on or accessed on the VDADrive (the VDA may be multi-thread to allow multiple files to be processed and maintain performance for the user; and VDA_UnVDAACP checks for file currently active and present in VDA Page by checking FCB Status. If the file is active, follow procedures as defined for active files (this may be conceptually the same as opening a file in multiple applications in Windows). If the file is not active currently then: the VDA_ChainACP service: receives information from the UnVDAACP service and retrieves VDA-Data Control entry for the file; locates Root Merkle chain link; loads the FCB; loads the ACL and checks access rights; loads the ACB and creates entry in chain for access; loads the CCB; loads the Storage control chain; loads the VCBs; loads the RCBs; runs the Fragment Chains; and passes the Fragment Locations to StorageACP for retrieval. VDA_StorageACP loads and assembles the fragments of the replicates for access, calls the CryptoACP as necessary to decrypt and/or decompress the assembled fragments, and passes the assembled fragments to the CacheACP with the FCB link. The VDA_CacheACP may load the fragments into the VDA Page structure, and the fragments of the start of the file are loaded into the VDABuffer until filled according to settings. These fragments are those attached to the file entry in the lettered VDADrive.

Note that VDA_GPUACP may be used to perform CPU intensive operations during hashing, encryption, and compression operations in particular, in some embodiments. This ACP can also be used to any CPU rigorous operation to prevent excessive CPU loading, in some embodiments.

In some embodiments, each Entry in the VD Page Structure can include the following: a Header, which can include UUID for VDA Page Entry, Pointer to FCB entry, File Control Block (FCB) UUID, Hash Link pointer to Next File in VDA Page, Hash Link pointer to Prior File in VDA Page, Hash Link pointer to first data block of VDA Page, Hash Link pointer to last data block of VDA Page, VDA Page Data Block Count, Fragment count for file, Fragment size (bytes), Pointer to VDABuffer Header for file, and/or any other suitable information; Data Blocks Prefix, which can include Fragment UUID(s) (more than one fragment may be contained in a block), Fragment Header Links to Fragment Headers, and/or any other suitable information; Data Blocks, which can be the data (in a protected format, encrypted or hashed) from the fragments assigned to this VDA Page block; and/or any other suitable information.

Each Entry in the VDA Buffer Structure can include the following: Memory Header, which can include UUID for VDA Page Entry, Pointer to VDA Page entry, Hash Link pointer to Next File, Hash Link pointer to Prior File, Hash Link pointer to first data block of VDABuffer, Hash Link pointer to last data block of VDABuffer, VDABuffer Data Block Count, Fragment count for file, Fragment size (bytes), Memory Block Link to Prior Status Block, Memory Block Link to Next Status Block, Memory Block Link to Active Status Block, and/or any other suitable information; Memory Data Blocks Prefix, which can include VDA Page UUID(s) (more than one fragment may be contained in a block), VDA Page data block links, VDABuffer Block Status (e.g., Active—User actively using, Prior—User Prior use data block, Next—User probable next data block, Purge—data block to be returned to unused memory block pool, and/or any other suitable information); Memory Data Blocks; and/or any other suitable information.

The data (in a protected format, encrypted or hashed) from the fragments can be assigned to this VDABuffer block, in some embodiments.

The implementation of the VDA-Data Control may require the use of hash calculations as noted in prior sections, in some embodiments. These calculations may be used to link various components within the VDA-Data Control in an unbreakable chain, in some embodiments. By using hash links, the ability to detect alterations in the VDA-Data Control may be protected and the VDA-Data Control is easy to verify, in some embodiments. The implementation may require the use of possibly several different hashes depending upon the chain components begin linked, in some embodiments.

In some embodiments, the database used for the VDA-Data Control may be required to have a high throughput ability as well as being able to protect the contents via encryption plus have the function of being able to work with Merkle Trees. In some embodiments, the database should be able to self-replicate tables to make multiple backups of the information contained in the VDA-Data Control across the VDA Store. In addition, the ability to encrypt the stored content may be a necessity with strong algorithms, in some embodiments.

In addition to the VDA-Data Control, there may be a requirement to store and maintain performance and related type data for analysis of performance and resolution of performance related problems, in some embodiments. The VDA-OverSeer database can be the same as chosen for the VDA-Data Control or another selection, in some embodiments. The monitoring data in this database may not necessarily be a critical dataset for VDA, in some embodiments. Should this database be lost or otherwise corrupted, it might not affect the ability to access, recover, or otherwise perform the core functions of VDA, in some embodiments.

Data may be managed in this database by the VDA_WatchACP process (the Watch Dog), in some embodiments. As the watch dog process scans for issues within the VDA sub-systems, it may also collect performance and other statistical information about the activities of the application, in some embodiments. This data may aid in determining bottlenecks and resolving data flow issues, in some embodiments.

In some embodiments, part of the gathering procedure may be to ‘roll up’ the collected data to: minimums; maximums; averages such as arithmetic mean (sum of values of a data set divided by number of values (most common method)), median (middle value separating the greater and lesser halves of a data set), mode (most frequent value in a data set), and mid-range (the arithmetic mean of the highest and lowest values of a set); deviations such as standard deviation (the frequently used measure of dispersion: it uses squared mean deviations), average absolute deviation (this is the sum of absolute values of the deviations divided by the number of observations), median absolute deviation (a statistic which uses the median, not the mean, of absolute deviations), and maximum absolute deviation (which is a calculation which uses the maximum absolute deviation); and/or any other suitable information.

The calculated values can then be accumulated or organized by daily, weekly and yearly values, in some embodiments.

The description below is an overview list of data to be gathered and held, in some embodiments.

In some embodiments, the monitoring database, VDA-OverSeer may collect the following types of data: Process Resource usage; Network utilization; I/O usage; File Operation Counts; File counts of VDA Store; File statistics of VDA Store; File performance of VDA Store; and/or any other suitable information.

It is recommended to use the Windows Performance Monitor to collect the information needed to access the performance of the VDA processes and use of resources on the PC, in some embodiments. This is a built-in utility and a template can be used to define the counters and other parameters of data collection, in some embodiments. In addition, there are programmatic interfaces to access the data as well as being able to display formatted analysis of the data that can be used, in some embodiments. An overview of setting up data collection is found at: https://www.windowscentral.com/how-use-performance-monitor-windows-10, which is hereby incorporated by reference herein in its entirety. An identified list of critical (in some embodiments) counters is: https://blogs.technet.microsoft.com/bulentozkir/2014/02/14/top-10-most-important-performance-counters-for-windows-and-their-recommended-values/, which is hereby incorporated by reference herein in its entirety. The setup may locate the collected database in the VDA directory and specify a maximum size, etc. to prevent excessive storage usage for this database, in some embodiments.

The WatchACP process may control this monitoring of the VDA processes via the Windows API interfaces that exist, in some embodiments. This may make several aspects of the user interface that require display of resource usage to be implemented easy to implement since the modules to display the data are available as part of windows, in some embodiments.

Various lossless data compression algorithms may be used, in some embodiments. For example, Huffman Coding, Run Length Encoding, Shannon Fano Algorithm, Arithmetic Encoding, Adaptive Huffman Encoding Algorithm, Lempel Zev Welch Algorithm, and Dictionary Based Encoding can be used, in some embodiments.

In some embodiments, the LZ4 compression algorithm can be used in the VDA. The algorithm has good performance and results in good overall compression ratios for most data configurations, in some embodiments. In addition, the VDA-Data Control allows the specification for a compression algorithm at the file level, in some embodiments.

In some embodiments, the user may be able to specify from a selection of algorithms which can be applied to compress files at the VDADrive level, by file type or other offered selection/filter methodology.

In some embodiments, there can be four ‘user visible pieces’ of VDA. The major user interface(s) is/are the VDD(s) that is/are created for the user to interact with VDA Store, in some embodiments. The VDA Store can be implemented as another storage system of the Windows Operating System, in some embodiments. Another interface of VDA can be via the tray icon in the system tray, in some embodiments. This icon can be created by the VDA_UI, a process that runs in the background, in some embodiments. The icon itself can be one user interface, in some embodiments. By animation, the icon can present status information to the user at a glance, in some embodiments. In some embodiments, another icon interface can be the ‘right click’ menus presented to the user, described below. In some embodiments, the application can have the usual start menu shortcuts as well as help.

The first interface, the VDADrive, can appear as just another drive in the Windows Environment, in some embodiments. This drive, with its assigned letter, can interact with the user just as any other drive does, in some embodiments. The user can click on the drive in File Explorer to access files, can see storage status in the ‘My PC’ display of file explorer and applications can interact with the VDADrive just as any other, in some embodiments.

Two of the interfaces may be presented to user by the system tray icon that is created by the VDA_UI, in some embodiments. Like many other applications, VDA can create a system tray icon that is used to provide an interface to an application that mainly runs in the background, in some embodiments. This icon can be used to show ‘balloon notifications’ for critical events of VDA as well as being animated to display a general status for the application, in some embodiments.

In some embodiments, another VDA interface can be the start menu entries described below. These entries can allow the user to interact with VDA without use of the tray icon, restart the user interface, restart VDA, or seek help, in some embodiments.

In some embodiments, the start menu entries to create for the user can include: Status, which runs VDA_Report and presents dashboards and reports about VDA; Settings which allows the user to alter settings of the application; Utilities including Verify VDA-Data Control (which runs VDA_Scan), Verify VDA Store Files (which runs VDA_Verify), Recover VDA-Data Control (which rRuns VDA_Recovery, Reassemble File from Fragments (which runs VDA_Reassemble), and/or any other suitable utilities; Shutdown VDA, which shuts down the VDA Application; Restart VDA User Interface, which restarts only the User Interface Component of VDA; Restart/Start VDA, which starts the VDA system if not running or shuts down and then starts the application; Uninstall VDA, which runs the uninstaller for VDA; Help, which displays the Help File for VDA; and/or any other suitable entries.

As previously noted, the VDD(s) can appear as any other drive in the Windows Operating System, in some embodiments. The VDD(s) can also appear as target option when other applications present save/save as dialogs to the user, in some embodiments. The VDADrive can be the prime user interface to VDA, in some embodiments.

The tray icon can be created by the VDA_UI application and serve as the ‘click on point’ for users to interface with VDA beyond accessing file stored in the VDA Store, in some embodiments. In some embodiments, the icon can display a high level status by: No action—VDA is idle and all is well; Spinning—VDA is processing a store or retrieval operation; Blinking—An event has occurred and a message waiting; Twirling—A maintenance operation is underway; and/or by performing any other suitable action.

The Tray Icon can also display a ‘Balloon popup’ message when critical conditions have been detected that require user intervention, in some embodiments.

The VDA Tray interface can be controlled by the VDA_UI, in some embodiments. This application can present a windowed interface to the user to allow them to easily access the layers of settings in VDA, in some embodiments. This application can be the method for the user to alter and manage the operation and settings in VDA, in some embodiments. It may offer recommendations for settings to guide the user, and warn the user should they attempt to alter settings in a manner that could cause abnormal or undesired operation of VDA, in some embodiments.

The main user interface may be a menu that is presented to the user when the tray icon is right clicked on, in some embodiments. The menu can have eight sections that are explained below, in some embodiments. Double clicking the icon can bring up a status display, in some embodiments. The right click menu can be the same as, or similar to, the start menu without the ‘uninstall’ option included, in some embodiments.

A status option when selected can display a summary of the ‘health’ of the VDA application and its resources, in some embodiments. This initial display can be a summary or overall display of the VDA status, in some embodiments. Options can be provided on the initial screen to go deeper into the various sub-status displays, in some embodiments. This display can be the default ‘double click’ action on the tray icon, in some embodiments. This display can be generated by the VDA_Report Component that produces all dashboards, statistics and reports of resources, data, etc. from the VDA application, in some embodiments.

A settings dialog can allow the user to alter the settings of VDA, and the VDA Store, in some embodiments. Alteration of these values (Section 0—VDA-Data Control Root contents) can greatly affect the operation of the VDA Store, in some embodiments. This settings menu interface can also allow the management of VDDs, adding and removing storage points in the VDA Store and etc., in some embodiments.

In some embodiments, a utilities option can offer to run the various utilities provided with the VDA system including: VDA_Scan, which can perform a quick validation scan of the hashed links in the VDA-Data Control to detect corruption or other issues; VDA_Verify, which can perform a deep verification of a file or files in the VDA Store (in some embodiments, this can verify both the integrity of the links in the VDA-Data Control as well as the data linked to the VDA-Data Control as fragments); VDA_Recovery, which can recover the VDA-Data Control from the stored fragments; VDA_Reassemble, which can reassemble files from the individual fragments as long as the proper user credentials are provided.

A shutdown option shuts down all VDA services and processes, in some embodiments. An ‘Are You Sure’ verification windows can be displayed before shutting down the system components, in some embodiments. The VDA System can be restarted from the Start Menu, in some embodiments.

A restart user interface option can restart the user interface components of VDA, in some embodiments. This can allow the clearing of interface issues without restarting the entire VDA system, in some embodiments.

A restart option can cause a restart of the entire VDA system, in some embodiments.

A context menu undelete files option can cause files that are marked as deleted, but not yet erased, when the deletion delay expires to be recovered, in some embodiments.

A context menu restore prior version option can cause the selection of a prior version of a given file to be made the current version, in some embodiments. Example, if there are versions 4; 3; and 2 of the file, then selection of 3 as the current version will change it to version 5 or the current version of the file, in some embodiments. The highest version number may always the current version, in some embodiments.

The user may eliminate some of all prior versions of a file via a purge file version context menu command, in some embodiments. The user can specify to keep one or more prior versions or no prior version, in some embodiments. If the user specifies to purge three versions, then the oldest three versions may be deleted, in some embodiments. The user may also specify specific versions number to be deleted, in some embodiments.

An Airplane option allows all the fragments of a selected file to be place on the local storage devices of the PC, in some embodiments. The fragments may be distributed over several folders created under the master Airplane Mode Directory, in some embodiments. Several False fragments may also be created to interfere with the possible attempt to ‘crack’ the airplane mode file, in some embodiments. The FCB status may be changed to AIRPLANE which causes retrievals to access local storage only, in some embodiments. The Fragments in the Airplane Folder may automatically be copied back to their original locations (to include and updates) after a set period of time and the internet connection is available, in some embodiments.

A Powershell script interface can be provided and used by administrators to automate many operations and perform maintenance operations on Windows Servers and PCs, in some embodiments. This interface may include a command line interface that enables a user to use a shell invocation of a program with a command added. The interface may also include an interface program and/or a communications class for Powershell inside the application to receive commands. In some embodiments, this interface may include a VDAShell application that communicates to Powershell or other shell systems (like Fish, Ksh, Bash, Csh, Tcsh, Zsh, etc.), in some embodiments.

The VDA-Data Control Chain ACP may perform operations on the VDA-Data Control upon requests from a VDA Ancillary fraggling and unfraggling Control processes, in some embodiments. These requests may create links in the VDA-Data Control that track the files stored in the VDA Storage and provide the means to reassemble the files from the fragments distributed across the different storage locations, in some embodiments. In addition, select portions of the VDA-Data Control control blocks may be added to the fragment stored, in some embodiments. This may allow the reconstruction of the VDA-Data Control links as well as reassembling the files, in some embodiments. Any operation that adds, alters, deletes, moves or changes a file in the VDA Store in any way may cause an operation to occur in the VDA-Data Control, in some embodiments. These processes include adding a version, purging a version, renaming, updating, and/or any other suitable operation, in some embodiments. For a given operation several control blocks may be altered and several new links created, in some embodiments.

The integrity of the VDA-Data Control must be able to be verified on a regular basis in order to ensure that the files stored within the VDA Store are able to be retrieved as well as new files stored, in some embodiments. For a quick verify, Merkle hash values can be recalculated for links between control blocks within the VDA-Data Control, in some embodiments. This process is performed by the utility VDA-Data Control Scan, in some embodiments.

A main purpose of the VDA-Data Control can be the management and control of the files stored in the VDA Store, in some embodiments. The Control Blocks can hold the equivalent of a disk directory and an auditing event log along with various access control and credentials for access to the files, in some embodiments.

A main purpose of the file registry within the VDA-Data Control can be to record the fragmentation of files across the disparate file locations that makeup the VDA Store, in some embodiments. Using this record of stored locations can allow the VDA Ancillary controller to direct the Storage Controller to retrieve one set of fragments for a given file whether from a single storage location or multiple ones, in some embodiments.

An added item to be tracked with the VDA-Data Control can be which files are active in the user cache, in some embodiments. When restarting, the VDA Ancillary control process can load a list of files that are active from the VDA-Data Control branch, in some embodiments. These files can then be requested from the VDA Store, in some embodiments. The Fragments can be retrieved and placed in the fragments caches which can then be processed by the VDA Ancillary Process to be reassembled into complete files, in some embodiments.

As mentioned above, a record (or log) of store (and retrieval) operations not completed may be maintained in order to ensure the files stored in VDA can be retrieved, in some embodiments. In some cases, a storage location may not be available. This could be due to an internet loss, disaster causing service interruptions or the disk drive is not currently attached to the PC. In these cases, the write operations not completed may be tracked, in some embodiments. The VDA-Data Control may be used for this purpose in conjunction with VDA Page file to track and control the uncompleted transactions, in some embodiments. As each uncompleted transaction is completed, the VDA Page entry may be removed and VDA-Data Control entries updated, in some embodiments.

The GPU ACP service may be used processes high CPU usage calculations necessary for hash and crypto operations required for VDA processing, in some embodiments. The other services and utilities of VDA can have these ‘CPU eating’ processes performed by this ACP, in some embodiments. This service can contain the code needed to run the high CPU calculations on a GPU processor of the PC, in some embodiments. This may offload the ‘cycles’ from main processor cores of the PC, in some embodiments. The user may experience no or lessened degradation of other applications using this methodology, in some embodiments.

The VDA ACP Process can be the directing process for the adding of files into the VDA Store, in some embodiments. When a file is added into the VDA Drive by the user, the VDA ACP manages the process of fragmenting, encrypting, replicating and storing the file, in some embodiments.

This process uses the other ACP services of VDA to encrypt, replicate, fragment and then store the file into the VDA Store, in some embodiments.

Small files are a particular issue when fragmenting, in some embodiments. They can cause two issues slack space creation; and fragmenting without encryption will not hide contents effectively, in some embodiments.

When fragmenting a small file, it may be necessary to pad, with random data, the actual file contents, in some embodiments. This can be indicated by setting the ‘small file indicator’ in the FCB, in some embodiments. This indicator may flag the state of the file fragments to the ACP processes so the file can be properly defragmented when accessed by the user, in some embodiments. In some embodiments, such small files can be stored in a specialized database to reduce slack space and having to pad the file.

The UnVDA ACP Process may be the directing process for the retrieval of files from the VDA Store, in some embodiments. When a file is ‘clicked on’ or opened in an application by the user, the UnVDA ACP can manage the process of defragmenting, unencrypting, and loading the file into the VDA Swap, VDA Page, and VDABuffer for the user to access, in some embodiments.

This process can use the other ACP services of VDA to encrypt, replicate, fragment and then store the file into the VDA Store, in some embodiments.

As shown in FIG. 10, the fragment locations can be loaded into the VDA Swap file and then, depending upon size and available space, the fragment contents can be loaded into the VDA Page file, in some embodiments. At this point, the fragments may still be encrypted and may be placed in the VDA Page in no particular (a random) order, in some embodiments. When the fragments are loaded into the VDA Buffer, they may be organized into the correct order and decrypted, in some embodiments. This ‘window’ into the file is then presented to the user in the application, in some embodiments.

If, during the retrieval of the fragments needed to reassemble the file, a fragment is missing or otherwise unavailable, the system may then attempt access the same fragment in another replicant, in some embodiments. Should no replicant version of the fragment be available, then the file may be marked as unavailable and an error issues for retrieving the file, in some embodiments. This condition should not occur as long as a reasonable number of replicants are selected and all the cloud or networked storage locations of the VDA Store are available, in some embodiments. Should the needed fragments temporary be unavailable due to the network being down or the Cloud Storage being temporary unavailable, then, when the Verify Utility runs (this is automatic for a missing fragment), it will replace the missing fragment(s) from other replicates and mark the file as normal status when all the replicant fragments are available again, in some embodiments. Should the recovery fail, the file will be marked as lost, in some embodiments. This should not ever occur unless a catastrophic situation has ensued, in some embodiments.

Version selection can occur in multiple ways, in some embodiments. A first may be that the user employs the content menu option which makes a prior version the highest version which will cause that version to be opened by default, in some embodiments. Another may be to specify the full file name with the version number, in some embodiments. That may look like “A TEXT FILE.TXT; 4”, in some embodiments. That would select and open version 4 of the file, in some embodiments.

A more complicated but available method is relative version selection, in some embodiments. In some embodiments, this syntax placed after the file extension can be: “; 0” (the Current Version); “; −1” (a version prior to the current version); “; −2” (two version prior the current version); and “; −0” (the last available version).

The Crypto ACP service may process encryption operations for VDA, in some embodiments. The Crypto ACP may pass some calculations to the GPU ACP service if they are compute intensive, in some embodiments. All the encryption libraries may exist within this ACP, in some embodiments. This ACP may be the ‘key holder’ for VDA, in some embodiments. If some message, file fragments, or parts of the VDA-Data Control need to be strongly encrypted, this ACP may perform the task, in some embodiments. This ACP may also processes authentication requests for VDA, in some embodiments.

The CryptoACP may not hold the keys as such, in some embodiments. Any keys or crypto certificates may be held within the VDA-Data Control within CCB entries and UAB entries, in some embodiments. In order to access this data the master key of VDA may be required, in some embodiments.

Crypto Libraries Sources—the following references are hereby incorporated by reference herein in their entireties:
https://en.wikipedia.org/wiki/Comparison_of_cryptography_libraries
https://www.gpg4win.org/
https://github.com/quozd/awesome-dotnet/blob/master/README.md#cryptography
AES-256 algorithm is available to download from https://github.com/kenkendk/sharpaescrypt/. This is a C# .NET AES Crypt package containing the C#class SharpAESCrypt.SharpAESCrypt, which provides file encryption and decryption using aescrypt file format
https://www.openpgp.org/
https://www.gnupg.org/

The referenced libraries above contain strong and reliable algorithms for encryption that can be used, in some embodiments. The use of one or more of these crypto methods should serve to protect the data of VDA without issue, in some embodiments.

User access control may a critical part of VDA, in some embodiments. VDA limits the users access to only the data actually active at the time, in some embodiments. Data not actively being accessed is kept encrypted and protected from other access on the PC, in some embodiments. All data of VDA may be owned by the VDA group and user setup during installation, in some embodiments. Although a knowledgeable user could penetrate this, in some embodiments, any changes to the access controls of VDA are alarmed and audited, in some embodiments. This method of securing the easy access of the data to only VDA users may provide a last line of protection against ransomware locking data stores, in some embodiments.

The user authentication to the VDA Store may be a critical component of the protection of VDA, in some embodiments. VDA may support any accepted methods of authentication and authorization for a user, in some embodiments. The user may be able to select which method they employ, in some embodiments. If a simple username and password method is selected, the user may be warned that a stronger method be used to ensure the security of the data, in some embodiments. A minimum of the simplest two-factor security may be recommended, in some embodiments. In some embodiments, methods of authentication can include: Username/Password; Two Factor authentication with SMS; Two Factor Authentication with one time password; Two Factor Authentication with time based code; Two Factor Authentication with external hardware key; Two Factor Authentication with Facial Recognition; and/or any other suitable method.

Autherntication Sources—the following references are hereby incorporated by reference herein in their entireties:
NIST (National Institute of Standards and Technology) Guidelines:
   https://nvlpubs.nist.gov/nistpubs/SpecialPublications/NIST.SP.800-63-3.pdf
   https://nvlpubs.nist.gov/nistpubs/SpecialPublications/NIST.SP.800-63a.pdf
   https://nvlpubs.nist.gov/nistpubs/SpecialPublications/NIST.SP.800-63b.pdf
   https://nvlpubs.nist.gov/nistpubs/SpecialPublications/NIST.SP.800-63c.pdf

The cache drives in the VDA_CacheACP may be ‘backups’ for the user level interface drives, in some embodiments. In some embodiments, should alarms for access involving the PC User layer be activated, the cache drives can be deleted and the memory used overwritten with random numbers (per NIST Special Publication 800-88 Revision 1).

The performance issue solution can be seen as part of the standard implementation for hard disk drives in the windows environment, in some embodiments. Users can enable the use of read and write caching on drives to improve performance, in some embodiments. The user access may be caches in memory (possibly paged out during high memory usage situations), in some embodiments. The double cache scheme here can be used to add security in a virtual image type concept, in some embodiments. If the PC User file cache is corrupted (or attacked) then a good copy can quickly be restored from the VDA User Layer, in some embodiments. This method may also prevent Cryptolocker methods to lock up files for ransom, in some embodiments.

The Cache ACP can control three data structures in VDA, in some embodiments.

The Cache ACP can control the flow of data from cache reference pointer on disk to cached fragments on disk to a file fragment window accessible to the user, in some embodiments. This may be a critical path of data for VDA, in some embodiments.

The Cache ACP can use the driver SDK of Windows to create and configure the VDDs that appear as lettered disk drives to the user, in some embodiments. The VDDs can be connected to VDABuffer and access the data contained there to present to the user application, in some embodiments.

As the user accesses the VDABuffer and nears end of data, the Cache ACP can load additional file fragments from the VDA Page file to always enable the user to rapidly access data, in some embodiments. As fragments are altered by the user, the fragments can be marked as ‘dirty’ so that when the user commits the file changes the particular fragments can be located quickly and written to the VDA Store with proper replicants, in some embodiments.

The VDA_StorageACP controller can be the interface between VDAstorm and the external (to VDAstorm) storage locations, in some embodiments. In some embodiments, this process may fork or spawn other sub-controller processes to manage storage type groups, such as: Local Sub-Controller (e.g., Local Drives and USB Drives); Mapped Sub-Controller (e.g., Mapped Drives); Network Sub-Controller (e.g., NAS Arrays, SAN Arrays, Other Networked Drives); Cloud Storage Sub-Controller (e.g., Box, DropBox, Google One, Microsoft OneDrive, Mega, Carbonite, Mimecast); Enterprise Cloud Sub-Controller (e.g., AWS, Azure, Wasabi Storage); and/or any other suitable storage controller(s).

The controller and sub-controllers can provide federated interface between the storage and VDAstorm, in some embodiments. The code in each sub-controller can provide a common method of interface from the VDAstorm Ancillary Process, in some embodiments.

The Local Storage layer can be the layer of the physical data storage, in some embodiments. This layer can hold the fragmented data from the user and the management and control databases for the VDAstorm product, in some embodiments. Per the user's settings for a given data item, folder, item type, or storage location the item's fragments will be distributed, in some embodiments. This can result in multiple VDDs being presented to the user for each configuration of physical storage, in some embodiments. There can be multiple drives to handle geographical requirements or take advantage of lower bandwidth costs for cloud access, in some embodiments.

The user may be able to specify what folders are to be used as storage destinations and how much storage may be consumed by VDA, in some embodiments. The user can configure the product to create a simple backup of files without fragmentation if desired, in some embodiments. This ability can be used as a method of testing the product prior to full deployment, in some embodiments.

As with Local Drives, the user may be able to specify what folders are to be used as storage destinations and how much storage may be consumed by VDA, in some embodiments. The user can configure the product to create a simple backup of files without fragmentation if desired, in some embodiments. This ability can be used as a method of testing the product prior to full deployment, in some embodiments. The user may take into consideration the I/O activity that could be created on the external drives when creating the setting for distribution of the data, in some embodiments.

As with Local Drives, the user can specify what USB, external drive, and mapped drive folders are to be used as storage destinations and how much storage may be consumed by VDA, in some embodiments. The user can configure the product to create a simple backup of files without fragmentation if desired, in some embodiments. This ability can be used as a method of testing the product prior to full deployment, in some embodiments. The user may take into consideration the I/O activity that could be created on the LAN when creating the setting for distribution of the data, in some embodiments. The settings may be coordinated with the manager of the SAN/NAS arrays, in some embodiments.

The user can specify what SAN/NAS drive folders are to be used as storage destinations and how much storage may be consumed by VDA, in some embodiments. The user can configure the product to create a simple backup of files without fragmentation if desired, in some embodiments. This ability can be used as a method of testing the product prior to full deployment, in some embodiments. When assigning VDA Store Locations on a file server, the placement and size of the stores may be coordinated with the server manager to ensure performance for other users will not be impacted, in some embodiments.

For Hybrid clouds, the user may be free to deploy fragments as he/she wishes, in some embodiments. This should be coordinated with the manager of the cloud service, in some embodiments.

The Mailbox ACP can be a communications service to pass messages efficiently and securely between the VDA ACPs and Utilities, in some embodiments. Mailbox data structures can be created within the VDA Page and VDABuffer constructs, in some embodiments. A mailbox can be created for each ACP process with an UUID and a name created from the process name, in some embodiments. Combined, they can create a unique mailbox name, in some embodiments. The mailbox can be addressed by the created name, in some embodiments. The mailboxes can be used between ACPs in a network allowing the distribution of workload within a LAN for server and cloud type installations, in some embodiments.

Another ACP process can present a message to be transmitted to another ACP process, a list of ACP Processes or broadcast to all other ACP processes, in some embodiments. The message can include data or simply be pointers or links to data structures to pass to the other process, in some embodiments.

In some embodiments, the Mailbox ACP can be based upon concepts from OpenVMS and are documented in:
https://support.hpe.com/hpsc/doc/public/display?docId=a00058404en_us the OpenVMS I/O Guide
   which is hereby incorporated by reference herein in its entirety.

The Watch ACP can have two major functions, in some embodiments. The first function can be to watch the health and performance of VDA and the second function can be to actively control the resource consumption of VDA, in some embodiments.

The Watch ACP can checks the health of the ACP service and other running processes of VDA, in some embodiments. In some embodiments, this scan of health may include: check that all required processes are running, issue Auditing Events and alerts, and restart missing processes; check the Hash values of VDA files involving in the processing for VDA, where the Hash values can be hidden in registry during installation, and check values to determine if any files have been tampered with, and use updates to update the registry values.

The Watch ACP can access the VDA-OverSeer database created by the Windows Performance Monitoring Process as setup during installation, in some embodiments. Use of this database can allow the Watch ACP to access the performance of VDA and determine if it is consuming an unreasonable amount of PC resources that will impact the users PC experience, in some embodiments. When the Watch ACP encounters excessive resource usage, the Watch ACP can alter process parameters to restore normal resource usage, in some embodiments. In some embodiments, the possible parameters to alter on active processes can include: CPU Priority; I/O Priority; Memory Priority; and/or any other suitable parameters.

Excessive resource usage may also create audit events with details of the excess usage, in some embodiments.

The interrelationship between a process or action to be taken and the services and user input (if any) that are involved in some embodiments are described below. These can be commands that may be issued to the ACP services or Processes that part of VDA, in some embodiments. Note, the GPU ACP may be used at any time if compute intensive operations are required to perform processes needed for operations, in some embodiments.

In some embodiments, to authenticate a user the ACP services used can include: WatchACP—authentication dialog; CryptoACP—processes credentials; ChainACP—stores event and user data; and/or any other suitable services. Through this process, a user inputs authentication information, in some embodiments. The user inputs can include: username; and password or other credentials, in some embodiments. As a result of this process, a user is authorized or denied access, in some embodiments.

In some embodiments, to add a user, the ACP services used can include: WatchACP—authentication dialog; CryptoACP—processes credentials; ChainACP—stores event and user data; and/or any other suitable services. Through this process, a user inputs authentication information, in some embodiments. The user inputs can include: username; and password or other credentials, in some embodiments. As a result of this process, a user is added to system or refused, in some embodiments.

In some embodiments, to remove a user, the ACP services used can include: WatchACP—authentication dialog; CryptoACP—processes credentials; ChainACP—stores event and user data; and/or any other suitable services. Through this process, a user inputs authentication information, in some embodiments. The user inputs can include: username; and password or other credentials, in some embodiments. As a result of this process, a user is removed or operation canceled, in some embodiments.

In some embodiments, to freeze a user the ACP services used can include: WatchACP—authentication dialog; CryptoACP—processes credentials; ChainACP—stores event and user data; and/or any other suitable services. Through this process, a user inputs authentication information, in some embodiments. The user inputs can include: username; and password or other credentials, in some embodiments. As a result of this process, a user is locked out, in some embodiments.

In some embodiments, to perform a directory listing, the ACP services used can include: ChainACP—access file and folder information; CryptoACP—Unlock VDA-Data Control data; CacheACP—loaded Directory Information to display in File Explorer; and/or any other suitable services. Through this process, VDA-Data Control DCBs, FoCBs, FCBs, VCBs, ReCBs and FrCBs Metadata can be loaded, summary data to display in file explorer can be loaded, and version, replicant and fragment summaries may be displayed, in some embodiments. The user inputs can include: staring File Explorer and select a VDA Drive, in some embodiments. As a result of this process, Windows File Explorer can display Files in VDA Store, in some embodiments.

In some embodiments, to List Files with options the ACP services used can include: ChainACP—access file and folder information; CryptoACP—Unlock VDA-Data Control data; CacheACP—loaded Directory Information to display in File Explorer; and/or any other suitable services. Through this process, VDA-Data Control DCBs, FoCBs, FCBs, VCBs, ReCBs and FrCBs Metadata can be load, summary data to display in file explorer can be loaded, and version, replicant and fragment summaries can be displayed, in some embodiments. The user inputs can include: starting File Explorer and select a VDA Drive with display filters or options, in some embodiments. As a result of this process, Windows File Explorer can displays Files in VDA Store per filters and options, in some embodiments.

In some embodiments, to add a file, the ACP services used can include: VDAACP—Manages process and fragments; StorageACP—Stores the fragments per settings; ChainACP—Creates the control block entries; CacheACP—Load the caches and memory; CryptoACP—Manages the Encryption Processes; and/or any other suitable services. Through this process, a file can replicated, encrypted, fragmented, and stored, in some embodiments. The user inputs can include: a file being placed into a VDA Drive, in some embodiments. As a result of this process, a file can be added to VDA Store, in some embodiments.

In some embodiments, to add a file version, the ACP services used can include: VDAACP—Manages process and fragments; StorageACP—Stores the fragments per settings; ChainACP—Creates the control block entries; CacheACP—Load the caches and memory; CryptoACP—Manages the Encryption Processes; and/or any other suitable services. Through this process, a file will have been altered and a version created, and the file will have a VCB added into the structure with all the RCB and etc. connected, in some embodiments. The user inputs can include: a file is added to VDA Drive and older files VCBs links updated, in some embodiments. As a result of this process, a file is added to VDA Store with a new version, in some embodiments.

In some embodiments, to alter file version settings, the ACP services used can include: VDAACP—Manages process and fragments; StorageACP—Stores the fragments per settings; ChainACP—Creates the control block entries; CacheACP—Load the caches and memory; CryptoACP—Manages the Encryption Processes; and/or any other suitable services. Through this process, a file will have been altered and a versioning altered, and VCB is updated to new settings. The user inputs can include: a version setting being altered, in some embodiments. As a result of this process, VCB settings can be updated with other control block settings, in some embodiments.

In some embodiments, to purge old file versions, the ACP services used can include: VDAACP—Manages process and fragments; StorageACP—Stores the fragments per settings; ChainACP—Creates the control block entries; CacheACP—Load the caches and memory; CryptoACP—Manages the Encryption Processes; and/or any other suitable services. Through this process, per user input, selected versions are deleted, in some embodiments. This operation is like a file deletion except only select versions are removed, in some embodiments. The user inputs can include: user specifies versions to purge/delete, in some embodiments. As a result of this process, prior versions per user input are removed, in some embodiments.

In some embodiments, to retrieve a specific version, the ACP services used can include: VDAACP—Manages process and fragments; StorageACP—Stores the fragments per settings; ChainACP—Creates the control block entries; CacheACP—Load the caches and memory; CryptoACP—Manages the Encryption Processes; and/or any other suitable services. Through this process, a file is specified is retrieved through usual unVDA process, in some embodiments. The user inputs can include: a user selecting a prior version of file. As a result of this process, a user accesses a specified file, in some embodiments.

In some embodiments, to perform version recovery for ransomware, the ACP services used can include: VDAACP—Manages process and fragments; StorageACP—Stores the fragments per settings; ChainACP—Creates the control block entries; CacheACP—Load the caches and memory; CryptoACP—Manages the Encryption Processes; Ransomware Application—scans files and requests prior version operations; and/or any other suitable services. Through this process, the application scans files with modified dates specified by user, and if application can't ‘open’ the file: the file can be declared and marked ‘locked’; an ACB event entry created; if older version is available, the older version is made current; and file is added to locked by ransomware report, in some embodiments. The user inputs can include: a user executing ransomware application, in some embodiments. As a result of this process, files locked with ransomware are identified and logged plus with versioning file are restored, in some embodiments.

In some embodiments, to encrypt a file, the ACP services used can include: CacheACP—Load Fragments to be operated on; ChainACP—Updates control blocks; StorageACP—Stores encrypted files; CryptoACP—Encrypts file per user; and/or any other suitable services. Through this process, file fragments are placed into VDA Swap and VDA Page structures, cryptoACP operates on fragments and StorageACP stores encrypted fragments, in some embodiments. The user inputs can include: a user specifying encryption method and credentials, in some embodiments. As a result of this process, a file is encrypted, in some embodiments.

In some embodiments, to decrypt a file, the ACP services used can include: CacheACP—Load Fragments to decrypt; ChainACP—Updates Control blocks; StorageACP—Retrieves Fragments to encrypt; CryptoACP—Decrypts file per user; and/or any other suitable services. Through this process, file fragments can be placed into VDA Swap and VDA Page structures, CryptoACP operates on fragments, and CacheACP makes unencrypted fragments available to user, in some embodiments. The user inputs can include: a user specifyings encryption method and credentials, in some embodiments. As a result of this process, a file can be unencrypted, in some embodiments.

In some embodiments, to alter a fragmentation setting, the ACP services used can include: ChainACP—Retrieve current settings; CacheACP—Loads fragments; StorageACP—Stores altered fragments; CryptoACP—Encrypts file per settings; and/or any other suitable services. Through this process, ChainACP alters control blocks, and StorageACP and CacheACP work to store fragments to new settings, in some embodiments. The user inputs can include: user inputs new specification for fragmentation and replication, in some embodiments. As a result of this process, file fragments and replicants are altered per user changes, in some embodiments.

In some embodiments, to retrieve a file, the ACP services used can include: UnVDAACP—Manages process and fragments; StorageACP—Loads the fragments per settings; ChainACP—Retrieves the control block entries; CacheACP—Load the caches and memory; CryptoACP—Manages the Encryption Processes; and/or any other suitable services. Through this process, a file is retrieved, and made available to the user on a VDA Drive, in some embodiments. The user inputs can include: a file being placed into a VDA Drive, in some embodiments. As a result of this process, a file is accessible to user, in some embodiments.

In some embodiments, to delete a file, the ACP services used can include: UnVDAACP—Manages process and fragments; StorageACP—Loads the fragments per settings; ChainACP—Retrieves the control block entries; CacheACP—Load the caches and memory; CryptoACP—Manages the Encryption Processes; and/or any other suitable services. Through this process, a file is marked as deleted, and a file can be undeleted until a specified time period lapses, in some embodiments. The user inputs can include: a file being deleted by user, in some embodiments. As a result of this process, a file is no longer accessible and the file's FCB is state deleted, in some embodiments.

In some embodiments, to undelete a file, the ACP services used can include: UnVDAACP—Manages process and fragments; StorageACP—Loads the fragments per settings; ChainACP—Retrieves the control block entries; CacheACP—Load the caches and memory; CryptoACP—Manages the Encryption Processes; and/or any other suitable services. Through this process, a file is marked as normal, in some embodiments. The user inputs can include: a file is undeleted by user, in some embodiments. As a result of this process, a file is accessible and a file FCB is state normal, in some embodiments.

In some embodiments, to set airplane mode, the ACP services used can include: UnVDAACP—Manages process and fragments; StorageACP—Loads the fragments per settings; ChainACP—Retrieves the control block entries; CacheACP—Load the caches and memory; CryptoACP—Manages the Encryption Processes; and/or any other suitable services. Through this process, a file is marked as in airplane mode, and the file fragments are loaded locally to a special airplane folder, in some embodiments. The user inputs can include: a file being selected by user, in some embodiments. As a result of this process, a file is available ‘offline’ for a period of time, in some embodiments.

In some embodiments, to cancel airplane mode, the ACP services used can include: UnVDAACP—Manages process and fragments; StorageACP—Loads the fragments per settings; ChainACP—Retrieves the control block entries; CacheACP—Load the caches and memory; CryptoACP—Manages the Encryption Processes; and/or any other suitable services. Through this process, a file is unmarked as in airplane mode, the file fragments are removed from the special folder, and the fragments are used to update the stored Fragments if any changes were made, in some embodiments. The user inputs can include: a file being selected by user or time period expires, in some embodiments. As a result of this process, a file is updated in the VDA Store and removed from the PC, and the file no longer available offline, in some embodiments.

VDA Ransomware Recovery can identify ransomware encrypted files and replace them with the prior version automatically once the application is started, in some embodiments. The application creates another version when it replaces the locked-out file, in some embodiments.

The VDA Ransomware Recovery Utility can identify ‘locked out’ files even if versioning is not turned on, in some embodiments. This can allow a user to create a list of files that have been locked out by the ransomware and then be able to run decryption tools against the file list, in some embodiments.

The Scan Utility can verify hashed links between components in the VDA-Data Control, in some embodiments. By tracing the hashed links, the utility can verify the integrity of the VDA-Data Control database quickly, in some embodiments. Any corrupted or missing component can be rapidly found and recovery of the missing information attempted by scan of the Fragment Blocks or by recovery of one of the replicated VDA-Data Control copies located in the VDA Store by use of the Recovery Utility, in some embodiments.

The Verify Utility can scans all control blocks associated with a file and then scan all the associated Fragment Blocks also, in some embodiments. This can verify the integrity of any file in the VDA Store, in some embodiments. Should fragments be missing, they can be recovered from other replicates within the VDA Store, in some embodiments.

This Recovery utility can check the integrity of VDA-Data Control and rebuilds the control blocks that were corrupted, in some embodiments. In some embodiments, this can be accomplished by use of the synchronized tables located from the VDA-Data Control in storage locations in the VDA Store or by scanning file fragments to rebuild the information contained for the file in the VDA-Data Control, in some embodiments.

This VDA Reassemble utility can be used in cases in which the VDA-Data Control is completely lost and only the storage locations remain intact, in some embodiments. This utility, with the proper user credentials, can scan the storage locations of the VDA Store and rebuild the files, in some embodiments. This operation attempts to recover all files that have one complete of fragments from any combination of replicants, in some embodiments. After it completes, the Recovery Utility can be run to reconstruct a VDA-Data Control, in some embodiments.

The VDA_UI is the User Interface application that can be run to present the user with settings management, dashboards for display of metadata about the files stored, in some embodiments. The application creates the VDA tray icon which the user will click on to access the functions of the user interface, in some embodiments.

The VDA Report application can produce reports about the events, resource usage, metadata concerning the VDA Store and other processes of VDA, in some embodiments. These reports can be exported to files such as MS Word documents and Excel spreadsheets, printed, and/or used in any other suitable manner, in some embodiments. This application can be accessed from the Start Menu or via the Tray Icon interface, in some embodiments.

The VDA Shell Application is the interface to the local PC scripting shell, in some embodiments. This application can provide a ‘translator’ between the given shell in use and the VDA product, in some embodiments. As the application is ported to other operating system environments, this application can be expanded to handle all the shell environments in those operating systems, in some embodiments.

The application can run in user space and waits for a command to be issued from a shell, in some embodiments. Once a command is received, it is logged in an ACB entry and then transmitted to the correct ACP via the Mailbox system, in some embodiments.

The mechanisms described herein can be implemented in any suitable computing device. For example, in some embodiments, the mechanisms described herein can be implemented using any suitable general-purpose computer or special-purpose computer(s). Any such general-purpose computer or special-purpose computer can include any suitable hardware. For example, as illustrated in example hardware 100 of FIG. 1, such hardware can include hardware processor 102, memory and/or storage 104, an input device controller 106, an input device 108, display/audio drivers 110, display and audio output circuitry 112, communication interface(s) 114, an antenna 116, and a bus 118.

Hardware processor 102 can include any suitable hardware processor, such as a graphical processing unit (GPU), a microprocessor, a micro-controller, digital signal processor(s), dedicated logic, and/or any other suitable circuitry for controlling the functioning of a general-purpose computer or a special purpose computer in some embodiments.

Memory and/or storage 104 can be any suitable memory and/or storage for storing programs, data, and/or any other suitable information in some embodiments. For example, memory and/or storage 104 can include random access memory, read-only memory, flash memory, hard disk storage, optical media, and/or any other suitable memory.

Input device controller 106 can be any suitable circuitry for controlling and receiving input from input device(s) 108, in some embodiments. For example, input device controller 106 can be circuitry for receiving input from an input device 108, such as a touch screen, from one or more buttons, from a voice recognition circuit, from a microphone, from a camera, from an optical sensor, from an accelerometer, from a temperature sensor, from a near field sensor, an automobile navigation system, from a global positioning system, and/or any other type of input device.

Display/audio drivers 110 can be any suitable circuitry for controlling and driving output to one or more display/audio output circuitries 112 in some embodiments. For example, display/audio drivers 110 can be circuitry for driving one or more display/audio output circuitries 112, such as an LCD display, a speaker, an LED, or any other type of output device.

Communication interface(s) 114 can be any suitable circuitry for interfacing with one or more communication networks. For example, interface(s) 114 can include network interface card circuitry, wireless communication circuitry, and/or any other suitable type of communication network circuitry.

Antenna 116 can be any suitable one or more antennas for wirelessly communicating with a communication network in some embodiments. In some embodiments, antenna 216 can be omitted when not needed.

Bus 118 can be any suitable mechanism for communicating between two or more components 102, 104, 106, 110, and 114 in some embodiments.

Any other suitable components can additionally or alternatively be included in hardware 100 in accordance with some embodiments.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable non-transitory tangible media. As another example, transitory computer readable media can include signals on networks, in wires, conductors, optical fibers, circuits, any suitable media that is fleeting and devoid of any semblance of permanence during transmission, and/or any suitable transitory intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention. Features of the disclosed embodiments can be combined and rearranged in various ways.

What is claimed is:

1. A method for storing an input file, comprising:
receiving the input file at a virtual disk drive;
encrypting the input file into a first instance of an encrypted file;
splitting the first instance of the encrypted file into a first plurality of fragments, using a hardware processor;
adding a fragment control structure to each fragment of the first plurality of fragments; and
storing each fragment of the first plurality of fragments to a corresponding storage location.

2. The method of claim 1, further comprising making an entry in a directory control structure to record the corresponding storage location for each fragment of the first plurality of fragments.

3. The method of claim 2, further comprising:
creating replicas, wherein each of the replicas is a replica of one of the plurality of fragments;
storing replicas to replica storage locations; and
recording identifiers of the replica storage locations in the directory control structure.

4. The method of claim 3, wherein no two replicas are located in the same storage location.

5. The method of claim 2, further comprising creating a fragment from one of the replicas.

6. The method of claim 5, wherein creating the fragment is performed using instructions stored in at least one of the other fragments.

7. The method of claim 1, further comprising:
for each fragment of the first plurality of fragments:
adding random bits to the fragment; and
hashing locations of the random bits into the fragment control structure of the fragment.

8. The method of claim 1, wherein the fragments are randomly or pseudo-randomly sized.

9. The method of claim 1, further comprising:
determining storage locations of the fragments;
retrieving the fragments from the storage locations;
determining the locations of the random bits in the fragments;
removing the random bits from the fragments;
removing the fragment control structure from each of the fragments;
joining the fragments into a second instance of the encrypted file;
decrypting the second instance of the encrypted file to form a decrypted file.

10. The method of claim 9, wherein the decrypted file is stored in a cache.

11. The method of claim 9, further comprising encrypting the decrypted file to form a re-encrypted file and storing the re-encrypted file in a cache.

12. The method of claim 9, wherein each fragment is stored as a fragment file in a storage location and wherein the method further comprises:
extracting metadata from the input file;
setting an owner of each fragment file to a user account associated with a mechanism for storing the fragment; and
setting an owner of an output file to be a user specified in the metadata, wherein the output file is based on the decrypted file.

13. The method of claim 12, further comprising setting a security setting of the output file to be a security setting specified in the metadata.

14. The method of claim 1, wherein storing each fragment of the first plurality of fragments to a corresponding storage location is performed non-sequentially.

15. The method of claim 1, wherein storing each fragment of the first plurality of fragments to a corresponding storage location is performed in a random or pseudo-random order.

16. The method of claim 1, further comprising:
after storing each fragment of the plurality of fragments,
in response to a command to save or modify the input file:
encrypting the input file into a third instance of an encrypted file;
splitting the third instance of the encrypted file into a second plurality of fragments;
adding a fragment control structure to each fragment of the second plurality of fragments;
storing each fragment of the second plurality of fragments to a corresponding storage location; and
creating and storing a version identifier associated with the second plurality of fragments.

17. The method of claim 16, further comprising:
tracking a number of versions of the input file; and
deleting an oldest plurality of fragments corresponding to the input file when the number of versions reaches a threshold.

18. The method of claim 1, further comprising:
for each storage location, access each fragment stored therein;
decrypt the fragment control structure;
compare data in the fragment control structure to data in a directory control structure; and
adding the data to the directory control structure if matching data is not present in the directory control structure.

19. The method of claim 1, further comprising:
for each storage location, access each fragment stored therein;
decrypt the fragment control structure; and
adding data from the fragment control structure to the directory control structure.

20. The method of claim 1, further comprising storing a fragment of a first input file and a fragment of a second input file in a single cluster within a storage location.

21. The method of claim 1, further comprising blocking access to the plurality of fragments in response to a user command.

22. The method of claim 1, further comprising blocking access to the plurality of fragments in response to a proximity determination.

23. The method of claim 1, further comprising blocking access to the plurality of fragments in response to detecting anomalous activity.

24. The method of claim 1, further comprising blocking access to the plurality of fragments in response to a notification.

25. The method of claim 1, further comprising creating a fragment from contents of other fragments.

26. The method of claim 1, wherein creating the fragment is performed using instructions stored in at least one of the other fragments.

27. The method of claim 1, wherein the encrypting the input file into a first instance of an encrypted file in performed in response to authenticating a first user, the method further comprising:
in response to authenticating a second user:
determining storage locations of the fragments;
retrieving the fragments from the storage locations;
determining the locations of the random bits in the fragments;
removing the random bits from the fragments;
removing the fragment control structure from each of the fragments;
joining the fragments into a second instance of the encrypted file; and
decrypting the second instance of the encrypted file to form a decrypted file.

28. The method of claim 1, further comprising:
receiving a request to access a file;
determining if a threshold number of users have been authenticated; and
in response to determining that the threshold number of users have been authenticated, granting access to the file.

29. A system for storing an input file, comprising:
memory; and
at least one hardware processor coupled to the memory and collectively configured to at least:
receive the input file at a virtual disk drive;
encrypt the input file into a first instance of an encrypted file;
split the first instance of the encrypted file into a first plurality of fragments;
add a fragment control structure to each fragment of the first plurality of fragments; and
store each fragment of the first plurality of fragments to a corresponding storage location.

30. A non-transitory computer-readable medium containing computer executable instructions that, when executed by a processor, cause the processor to perform a method for storing an input file, the method comprising:
receiving the input file at a virtual disk drive;
encrypting the input file into a first instance of an encrypted file;
splitting the first instance of the encrypted file into a first plurality of fragments;
adding a fragment control structure to each fragment of the first plurality of fragments; and
storing each fragment of the first plurality of fragments to a corresponding storage location.
